(19) United States
(12) Patent Application Publication
(10) Pub. No.: US 2024/0348586 A1
(43) Pub. Date: Oct. 17, 2024

(54) USING SEVERAL GATEWAYS FOR PERFORMING DATA MESSAGE ENCRYPTION NEEDED FOR POLICY-BASED VIRTUAL PRIVATE NETWORK COMMUNICATIONS

(71) Applicant: VMware LLC, Palo Alto, CA (US)

(72) Inventors: Gaurav Jindal, Pune (IN); Rasik Vallabhbhai Jesadiya, Pune (IN); Hussaina Begum Nandyala, Allagadda (IN); Neeraj Mantri, Pune (IN)

(21) Appl. No.: 18/134,470

(22) Filed: Apr. 13, 2023

(51) Int. Cl. H04L 9/40; H04L 12/46; H04L 41/0894; H04L 41/22

(52) U.S. Cl. CPC H04L 63/0272; H04L 12/4633; H04L 41/0894; H04L 41/22

(57) ABSTRACT

Some embodiments provide a novel method for dynamically performing data message encryption for machines of a first network at several gateways. The encryption is needed for VPN communication with a second network. The method receives, through a user interface, a VPN policy associated with a first segment set of the first network. The method uses a first gateway to establish VPN sessions for a first machine set associated with the first segment set, uses a second gateway to perform encryption operations for the first machine set, and uses the first gateway to perform encryption operations for a second machine set associated with a second segment set of the first network. The method monitors load on the first or second gateways. Based on the monitored load, the method uses a third gateway to perform encryption operations for a third machine set associated with a third segment set of the first network.

### BACKGROUND

Internet Protocol Secure (IPsec) is a group of protocols that are used together to set up encrypted connections between devices such that private data can be securely sent over public networks. IPsec is often used to set up Virtual Private Networks (VPNs) by encrypting IP packets and authenticating the source of the packets. IPsec VPN is widely used by enterprises to interconnect their geographical dispersed branch office locations across the Wide Area Network (WAN) or the Internet, especially in the Software-Defined-WAN (SD-WAN) era. IPsec is also used by cloud providers to encrypt IP traffic traversing datacenter interconnect WAN so as to meet the security and compliance requirements, especially in financial cloud and governmental cloud environments.

Internet Key Exchange (IKE) is the protocol used to set up a secure and authenticated communications channel between two parties. IKE typically uses public key infrastructure certificates for authentication and the key exchange protocol to set up a shared session secret. IKE is part of the IPsec, which is responsible for negotiating security associations (SAs), which are a set of mutually agreed-upon keys and algorithms to be used by both parties trying to establish a VPN connection/tunnel.

For many enterprises in on-premises and cloud deployments, there are few VPN sessions terminating on the VPN gateway while the requirement for traffic over a VPN is high. Having a single VPN gateway perform both VPN session establishment and data message encryption can result in overloading the VPN gateway. Hence, methods and systems are needed for offloading data message encapsulation from a VPN gateway that establishes the VPN session to one or more other gateways.

### BRIEF SUMMARY

Some embodiments provide a novel method for reducing load on a first virtual private network (VPN) gateway of a first datacenter by using a second VPN gateway to perform data message encryption needed for VPN communication with a second datacenter. The second VPN gateway of some embodiments performs data message encryption for several machines executing on several host computers of the first datacenter. The first VPN gateway establishes a VPN session with a third VPN gateway of the second datacenter and establishes a tunnel between the first and third VPN gateways. The first VPN gateway provides, to the second VPN gateway, state information specifying that the second VPN gateway is to perform encryption for a set of data messages exchanged along the tunnel. The first VPN gateway receives, from the second VPN gateway, an encrypted data message to be sent along the tunnel to a destination machine in the second datacenter. The first VPN gateway forwards the encrypted data message to the third VPN gateway of the second datacenter for the third VPN gateway to forward to the destination machine.

The encrypted data message is in some embodiments received as an unencrypted data message at the second VPN gateway from a source machine in the first datacenter that is a source of the unencrypted data message. The source machine provides the unencrypted data message to the second VPN gateway for encryption. After receiving the unencrypted data message, the second VPN gateway determines that it is assigned to perform encryption for this data message. Then, the second VPN gateway encrypts the data message and provides the encrypted data message to the first VPN gateway for forwarding to its destination.

In some embodiments, the source machine executes on a particular host computer and the second VPN gateway is a VPN gateway device of the first datacenter. In such embodiments, the second VPN gateway is a hardware gateway device of the first datacenter. In other embodiments, the source machine executes on a first host computer of the first datacenter and the second VPN gateway executes on a second host computer of the first datacenter. In such embodiments, the second VPN gateway may perform data message encryption for the machines executing on the same host computer (i.e., the second host computer) along with other machines executing on other host computers in the first datacenter.

The second VPN gateway, in some embodiments, is part of a set of VPN gateways of the first datacenter that performs the data message encryption. The first datacenter may deploy any number of gateways to perform data message encryption for the first VPN gateway. In such embodiments, before providing the state information to the second VPN gateway, the first VPN gateway performs a load balancing operation to select the second VPN gateway from the set of VPN gateways to perform the data message encryption for the VPN session. The first VPN gateway of some embodiments includes a load balancing module that is responsible for distributing data message encryption operations among the set of VPN gateways.

In some embodiments, the VPN session is established by (1) using an internet key exchange (IKE) protocol, during an IKE session with the third VPN gateway, to establish the tunnel, and (2) defining one or more encryption parameters, one or more authentication parameters, and a security association (SA) for the VPN session. The encryption parameters and authentication parameters may respectively include an encryption key and an authentication key used by the first and third VPN gateways during the VPN session. In some embodiments, the SA is an establishment of shared security attributes between the first and third VPN gateways to support secure communication. In some embodiments, it is a mutually agreed-upon key and algorithm to be used by the first and third VPN gateways.

Providing the state information to the second VPN gateway in some embodiments includes providing a record entry that includes a security parameter index (SPI) identifying the SA and an identifier identifying the second VPN gateway as the VPN gateway that is to perform data message encryption for data messages associated with the SA including the set of data messages. An SPI in some embodiments is a unique identifier for the SA. The record entry specifies which VPN gateway (e.g., the second VPN gateway) is to perform data message encryption for data messages specifying the SPI (i.e., for data messages exchanged along the SA).

The first VPN gateway in some embodiments stores the record entry in a first record table of the first VPN gateway, while the second VPN gateway stores the record entry in a second record table of the second VPN gateway. Each VPN gateway uses the record table to determine which VPN gateway is assigned to perform data message encryption for a received data message. If a VPN gateway determines that itself is assigned encryption for a received data message, it performs the data message encryption and forwards it along. If it determines that a different VPN gateway is assigned encryption for a received data message, it does not perform any encryption and forwards it along. For example, after receiving the encrypted data message and before forwarding the encrypted data message, the first VPN gateway performs a lookup in the first record table to determine that the second VPN gateway is assigned to encrypt data messages including the encrypted data message associated with the SPI. After determining this, the first VPN gateway knows that the data message has already been encrypted and can forward it to the third VPN gateway in the second datacenter.

In some embodiments, the encrypted data message is a first encrypted data message and the destination machine is a first destination machine. In such embodiments, the first VPN gateway receives a second encrypted data message from the third VPN gateway of the second datacenter. The second encrypted data message originated from a machine in the second datacenter and is destined for a second destination machine in the first datacenter. The first VPN gateway determines that the second encrypted data message is to be decrypted by the second VPN gateway, which can be performed using the first VPN gateway's first record table. Then, the first VPN gateway provides the second encrypted data message to the second VPN gateway for the second VPN gateway to decrypt and provide to the second destination machine.

The set of data messages may be a first set of data messages, the tunnel may be a first tunnel, and the VPN session may be a first VPN session. In such embodiments, the first VPN gateway may perform data message encryption for a second set of data messages exchanged along a second tunnel established for a second VPN session with the third VPN gateway. The second VPN gateway is used in such embodiments to perform some data message encryption for the first VPN gateway, but not all data message encryption. This can be done to alleviate the load on the first VPN gateway. In some embodiments, the second set of data messages is destined for the destination machine, i.e., the same destination machine as the first set of data messages. In other embodiments, the destination machine is a first machine, and the second set of data messages is destined for a second destination machine in the second datacenter.

In some embodiments, the tunnel is an Internet Protocol Security (IPsec) tunnel. The IPsec tunnel connects the first and second datacenters over a network such as a wide area network (WAN) (e.g., the Internet). The first and second datacenters are in some embodiments software defined datacenters (SDDCs).

Some embodiments provide a novel method for dynamically performing data message encryption operations for several machines of a first network at several gateways. The data message encryption is in some embodiments needed for VPN communication with a second network. The method receives, through a user interface (UI), a VPN policy that is associated with a first set of segments of the first network. The method uses a higher-level, first gateway to establish VPN sessions for a first set of machines associated with the first set of segments, while using a lower-level, second gateway to perform encryption operations for the first set of machines and using the first gateway to perform encryption operations for a second set of machines associated with a second set of segments of the first network. The method monitors load on the first or second gateways. Based on the monitored load, the method uses a lower-level, third gateway to perform encryption operations for a third set of machines associated with a third set of segments of the first network.

In some embodiments, the VPN policy is received in an Application Programming Interface (API). In other embodiments, the VPN policy is received through a graphical user interface (GUI). In such embodiments, the GUI may include a UI control through which a user specifies the first set of segments. For instance, the UI control may be a drop down window, a field to provide a set of network addresses (e.g., Internet Protocol (IP) values), a field to specify an IP prefix or a Classless Inter-Domain Routing (CIDR), etc.

The method of some embodiments uses the first gateway to establish the VPN sessions by providing the VPN policy to the first gateway for the first gateway to establish the VPN sessions. The first gateway can use this information to negotiate one or more SAs and one or more keys for the VPN sessions. Then, the first gateway can assign the one or more SAs to the second gateway and provide the one or more keys to the second gateway so it can perform encryption operations for the SAs.

In some embodiments, the first set of segments associated with the VPN policy includes several segments such that the VPN policy is defined by reference to the several segments. In other embodiments, the first set of segments associated with the VPN policy includes only one particular segment such that the VPN policy is defined by reference to the particular segment. For instance, a user may define a VPN policy for only one segment of the first network, or may define one VPN policy for several segments of the first network. These segments may be shown to the user through the UI (e.g., in a GUI) for the user to select for the VPN policy.

In some embodiments, the method monitors the load on the second gateway. In such embodiments, the method uses the third gateway to perform encryption operations for the third set of machines based on the monitored load by (1) determining that the load on the second gateway by the first set of machines exceeds a particular threshold, and (2) deploying the third gateway in the first network to perform the encryption operations for the third set of machines associated with the third set of segments.

The third set of machines in such embodiments is a first subset of the first set of machines and the third set of segments is a first subset of the first set of segments. The second gateway in some embodiments continues to perform encryption operations for a second subset of the first set of machines associated with a second subset of the first set of segments. When the method determines that the load on the second gateway exceeds the particular threshold, the method splits the first set of machines into first and second subsets of machines, so that the third gateway can take on the load of the first subset of machines and the second gateway can keep only the load of the second subset of machines. This helps preventing the second gateway from being overloaded.

In other embodiments, the method monitors the load on the first gateway. In such embodiments, the method uses the third gateway to perform encryption operations for the third set of machines based on the monitored load by (1) determining that the load on the first gateway by the second set of machines exceeds a particular threshold, and (2) deploying the third gateway in the first network to perform the encryption operations for the third set of machines associated with the third set of segments.

The third set of machines in such embodiments is a first subset of the second set of machines and the third set of segments is a first subset of the second set of segments. The first gateway in some embodiments continues to perform encryption operations for a second subset of the second set of machines associated with a second subset of the second set of segments. When the method determines that the load on the first gateway exceeds the particular threshold, the method splits the second set of machines into first and second subsets of machines, so that the third gateway can take on the load of the first subset of machines and the first gateway can keep only the load of the second subset of machines. This helps preventing the first gateway from being overloaded.

In some embodiments, the VPN policy is a first VPN policy, and the first gateway performs the encryption operations for the second set of machines associated with the second set of segments based on a second VPN policy that is associated with the second set of segments. In such embodiments, the second VPN policy associated with the second set of segments was received through the UI, and the method uses the first gateway to establish other VPN sessions for the second set of machines associated with the second set of segments.

The machines in each machine set in some embodiments include VMs. In some embodiments, a first machine in the first set of machines and a second machine in the second set of machines operate on a same host computer, namely multiple segments can include machines executing on the same host computers. In some embodiments, the method is performed by a set of one or more controllers of the first network that deploy and configure the gateways in the first network. The VPN policy may be received by the set of controllers from a set of one or more managers of the first network, that manages the set of controllers, that received the policy through the UI.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates an IKE session of some embodiments between an initiator at a first datacenter and a responder at a second datacenter for establishing secure communications between the datacenters.

FIG. 2 conceptually illustrates a VPN session, in some embodiments, between the initiator and responder to send data across the network using multiple paths in multiple uplinks or tunnels.

FIG. 3 conceptually illustrates a process of some embodiments for reducing load on a first VPN gateway of a first datacenter by using a second VPN gateway to perform data message encryption needed for VPN communication with a second datacenter.

FIG. 4 conceptually illustrates a process of some embodiments for reducing load on a first VPN gateway of a first datacenter by using a second VPN gateway to perform data message decryption needed for VPN communication with a second datacenter.

FIG. 5 illustrates an example record table for storing information regarding SPIs and the VPN gateways that perform encryption for data messages associated with the SPIs.

FIG. 6 conceptually illustrates a process of some embodiments for performing data message encryption for a first VPN gateway in a first datacenter that establishes VPN sessions with a second datacenter.

FIG. 7 conceptually illustrates a process of some embodiments for performing data message decryption for a first VPN gateway in a first datacenter that establishes VPN sessions with a second datacenter.

FIG. 8 illustrates a block diagram of a system for a first datacenter to communicate with a second datacenter using two gateway devices.

FIG. 9 illustrates a block diagram of a system for a first datacenter to communicate with a second datacenter using a gateway device and a gateway deployed on a host computer.

FIG. 10 illustrates a block diagram of a system for a first datacenter to communicate with a second datacenter using three gateway devices.

FIG. 11 illustrates a block diagram of a system that is implemented for gateways or edge appliances of a datacenter in some embodiments to perform establishment of a VPN session and encryption for data messages exchanged for that VPN session.

FIG. 12 illustrates a default gateway of a datacenter that load balances encryption processes for VPN communications to a set of encryption gateways in the datacenter.

FIG. 13 illustrates an SDDC that performs data message encryption at different gateways for different traffic groups of machines.

FIGS. 14A-B illustrate an example SDDC that is a public cloud availability zone in which a VPC has been defined for an entity to perform data message encryption at different gateways for different traffic groups of machines.

FIG. 15 illustrates an example SDDC that performs data message encryption at different gateways for different segments of the SDDC.

FIG. 16 conceptually illustrates a process of some embodiments for dynamically performing data message encryption operations for several machines of a first network at several gateways.

FIG. 17 conceptually illustrates a process of some embodiments for assigning data message encryption for different segments of a first datacenter to different VPN gateways of the first datacenter.

FIG. 18 illustrates a block diagram of a host machine of some embodiments for use in a virtualized networking environment.

FIG. 19 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for reducing load on a first virtual private network (VPN) gateway of a first datacenter by using a second VPN gateway to perform data message encryption needed for VPN communication with a second datacenter. The second VPN gateway of some embodiments performs data message encryption for several machines executing on several host computers of the first datacenter. The first VPN gateway establishes a VPN session with a third VPN gateway of the second datacenter and establishes a tunnel between the first and third VPN gateways. The first VPN gateway provides, to the second VPN gateway, state information specifying that the second VPN gateway is to perform encryption for a set of data messages exchanged along the tunnel. The first VPN gateway receives, from the second VPN gateway, an encrypted data message to be sent along the tunnel to a destination machine in the second datacenter. The first VPN gateway forwards the encrypted data message to the third VPN gateway of the second datacenter for the third VPN gateway to forward to the destination machine.

In some embodiments, the source machine executes on a particular host computer and the second VPN gateway is a VPN gateway device of the first datacenter. In such embodiments, the second VPN gateway is a hardware gateway device of the first datacenter. In other embodiments, the source machine executes on a first host computer of the first datacenter and the second VPN gateway executes on a second host computer of the first datacenter. In such embodiments, the second VPN gateway may perform data message encryption for the machines executing on the same host computer (i.e., the second host computer) along with other machines executing on other host computers in the first datacenter.

In some embodiments, the tunnel is an Internet Protocol Security (IPsec) tunnel. The IPsec tunnel connects the first and second datacenters over a network such as a wide area network (WAN) (e.g., the Internet). The first and second datacenters are in some embodiments software defined datacenters (SDDCs). A gateway can also be referred to as a gateway, an edge, an edge gateway, or an edge forwarding element. A gateway can refer to a hardware gateway device or a software gateway operating on a host computer.

Some embodiments provide a novel method for assigning data message encryption for different segments of a first datacenter to different VPN gateways of the first datacenter. The data message encryption is needed in some embodiments for VPN communication with a second datacenter. The first datacenter may include (1) a first VPN gateway that establishes a set of VPN sessions with the second datacenter, and (2) a second VPN gateway that performs the data message encryption for a set of segments of the first datacenter for the set of VPN sessions. The method may be performed by a set of one or more controllers.

The controller set of some embodiments receives, from a user, a definition of a particular VPN for a particular segment of the first datacenter. The controller set determines that a load on the second VPN gateway exceeds a particular threshold. The controller set deploys a third VPN gateway in the first datacenter. The controller set assigns the particular segment to the third VPN gateway by defining a particular routing policy for the third VPN gateway and the particular segment. The controller set provides the particular routing policy to the first VPN gateway for the first VPN gateway to establish a particular VPN session for the particular segment for which the third VPN gateway will perform data message encryption.

As used in this document, data messages refer to a collection of bits in a particular format sent across a network. One of ordinary skill in the art will recognize that the term data message is used in this document to refer to various formatted collections of bits that are sent across a network. The formatting of these bits can be specified by standardized protocols or non-standardized protocols. Examples of data messages following standardized protocols include Ethernet frames, IP packets, TCP segments, UDP datagrams, etc.

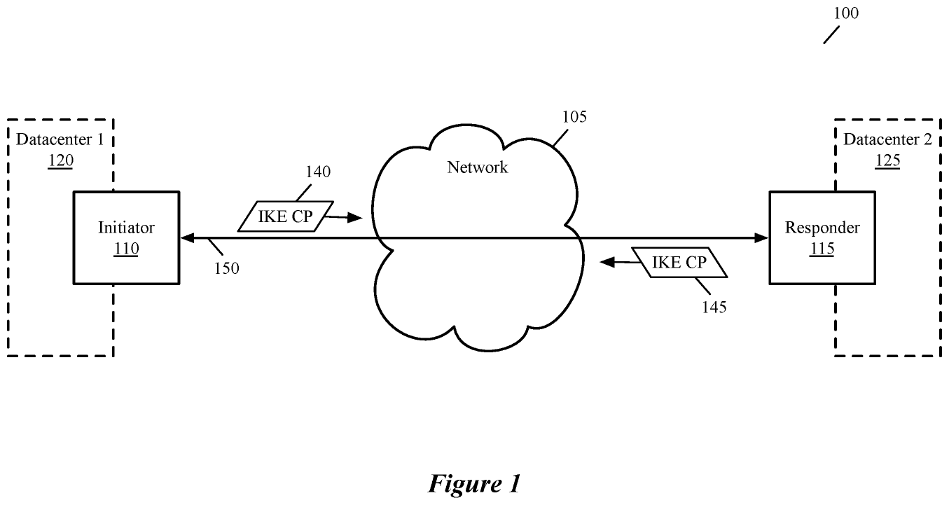

FIG. 1 conceptually illustrates an Internet Key Exchange (IKE) session of some embodiments between an initiator at a first datacenter and a responder at a second datacenter for establishing secure communications between the datacenters. In some embodiments, the IKE session 100 is used for establishing a VPN session between the first and second datacenters 120 and 125. The initiator 110 and responder 115 are gateways, according to some embodiments. During the IKE session, the initiator 110 and responder 115 establish an IPsec tunnel 150 using the IKE protocol. The IPsec tunnel 150 is then used by the initiator 110 and responder 115 to negotiate encryption, authentication, and other protocols and other parameters (e.g., security associations (SAs)), as illustrated by the control messages 140 and 145.

The network 105, in some embodiments, is implemented by an underlying physical infrastructure of wired and/or wireless communications mediums, routers, switches, etc., and, in some embodiments, may include the Internet, as well as any direct connections between the initiator 110 and responder 115. In some embodiments, the direct connections may refer to interconnections between network endpoints within a same datacenter and/or a same physical device, or other proprietary network connection interconnecting the initiator 110 and responder 115.

During the IKE session between the initiator 110 and responder 115, the initiator 110 and responder 115 negotiate an SA policy (e.g., an access list). This policy specifies which traffic is allowed to be exchanged along the tunnel that is created during the IKE session. In some embodiments, an SA policy specifies that traffic matching specified local and remote subnets and a corresponding security rule (e.g., a firewall rule) is allowed to be exchanged for the SA. The initiator 110 and responder 115 also create matching shared secret keys, negotiate IPsec SA parameters, and establish IPsec SAs (also referred to as IPsec tunnels). Once the IKE session is complete, the initiator 110 and responder 115 can exchange information via an IPsec SA created during the IKE session.

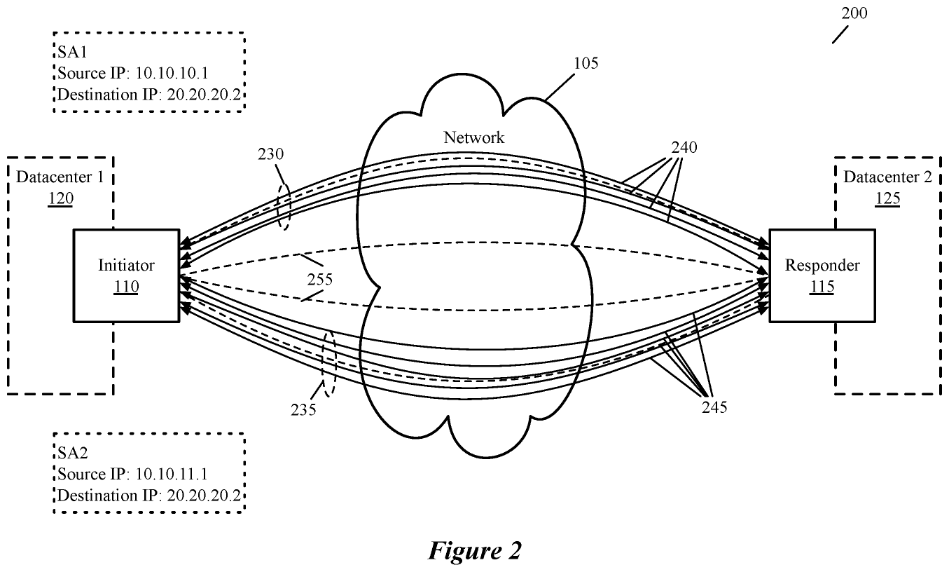

FIG. 2 conceptually illustrates a VPN session 200, in some embodiments, between the initiator 110 and responder 115 to send data across the network 105 using multiple paths in multiple uplinks or tunnels. In this example, the VPN session 200 uses two SAs to send data across the network 105. The SA1 is used to encrypt and authenticate IPsec data for a VPN tunnel (or uplink) 230, which is associated with a source IP 10.10.10.1 and a destination IP 20.20.20.2, and the SA2 is used to encrypt and authenticate IPsec data for a VPN tunnel (or uplink) 235, which is associated with a source IP 10.10.11.1 and the destination IP 20.20.20.2. Specifically, any flows communicated from endpoints (e.g., machines, virtual machines (VMs), containers, Pods, etc.) in the datacenter 120 to endpoints in the datacenter 125 may be encrypted at the first datacenter using SA1 and sent over the VPN tunnel 230, such as the flows 240, or using SA2 and sent over the VPN tunnel 235, such as the flows 245. Each of these VPN tunnels is a specific path through the network to which the SAs are pinned, represented by dashed lines between the initiator 110 and responder 115. As shown, additional paths 255 are available, to which neither of the SAs is pinned.

In some embodiments, the gateway 110 is configured to support VPN policies using SA policies. Egressing traffic from the gateway 110 is encrypted and sent to the VPN peer, and the receiving gateway 115 decrypts the ingress traffic according to the SA. In some embodiments, each SA has a different SPI value associated therewith, and the SA can be identified by a gateway using the SA's SPI in order to encrypt or decrypt traffic.

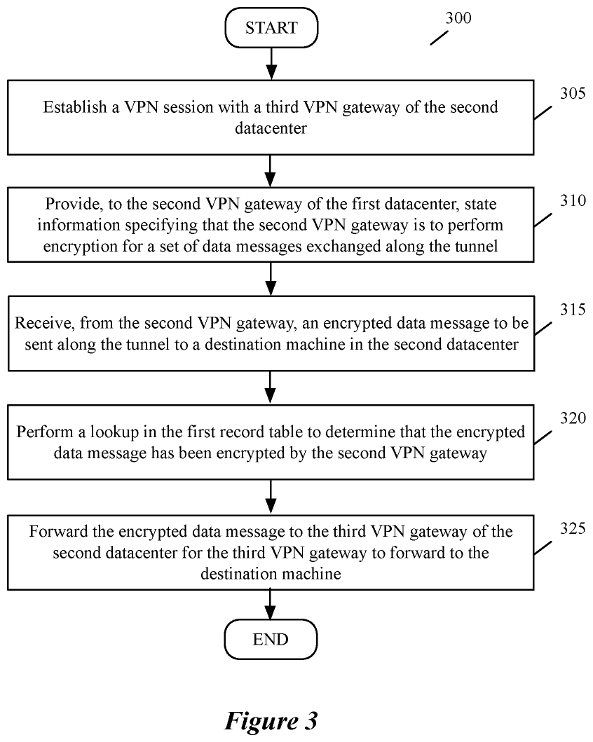

A VPN gateway of some embodiments utilizes a second VPN gateway in the same datacenter to perform data message encryption needed for VPN communication with another datacenter. FIG. 3 conceptually illustrates a process 300 of some embodiments for reducing load on a first VPN gateway of a first datacenter by using a second VPN gateway to perform data message encryption needed for VPN communication with a second datacenter. This process 300 may be performed by the first VPN gateway which is a default VPN gateway of a datacenter, such as the gateway 110 of FIG. 1, for egress data messages (i.e., data messages exiting the first datacenter). The second VPN gateway of some embodiments performs data message encryption for several machines executing on several host computers of the first datacenter in order to alleviate operations performed by the first VPN gateway. The first and second datacenters are in some embodiments software defined datacenters (SDDCs).

The process 300 begins by establishing (at 305) a VPN session with a third VPN gateway of the second datacenter. In some embodiments, the VPN session is established by (1) using an IKE protocol, during an IKE session with the third VPN gateway, to establish the tunnel, and (2) defining one or more encryption parameters, one or more authentication parameters, and an SA for the VPN session. The encryption parameters and authentication parameters may respectively include an encryption key and an authentication key used by the first and third VPN gateways during the VPN session.

In some embodiments, the SA is an establishment of shared security attributes between the first and third VPN gateways to support secure communication. In some embodiments, it is a mutually agreed-upon key and algorithm to be used by the first and third VPN gateways. During the establishment of the VPN session, the first VPN gateway establishes a tunnel between the first and third VPN gateways. In some embodiments, the tunnel is an Internet Protocol Security (IPsec) tunnel. The IPsec tunnel connects the first and second datacenters over a network such as a wide area network (WAN) (e.g., the Internet).

Next, the process 300 provides (at 310), to the second VPN gateway, state information specifying that the second VPN gateway is to perform encryption for a set of data messages exchanged along the tunnel. The second VPN gateway, in some embodiments, is part of a set of VPN gateways of the first datacenter that performs the data message encryption. In such embodiments, before providing the state information to the second VPN gateway, the first VPN gateway may perform a load balancing operation to select the second VPN gateway from the set of VPN gateways to perform the data message encryption for the VPN session. Further information regarding load balancing data message encryption operations among a set of VPN gateways will be described below.

In some embodiments, the first VPN gateway provides a record entry to the second VPN gateway that includes a particular SPI identifying the SA and an identifier identifying the second VPN gateway as the VPN gateway that is to perform data message encryption for data messages associated with the SA including the set of data messages. An SPI in some embodiments is a unique identifier for the SA. The record entry specifies which VPN gateway (e.g., the second VPN gateway) is to perform data message encryption for data messages specifying the SPI (i.e., for data messages exchanged along the SA).

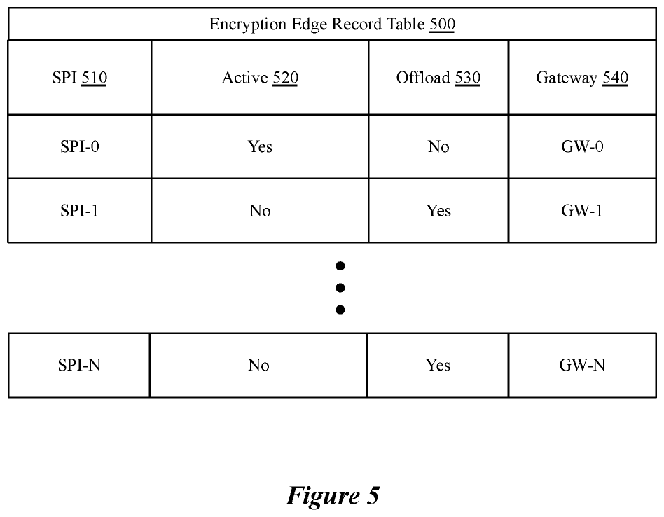

The first VPN gateway in some embodiments stores the record entry in a first record table of the first VPN gateway, while the second VPN gateway stores the record entry in a second record table of the second VPN gateway. Each VPN gateway in some embodiments uses a record table to determine which VPN gateway is assigned to perform data message encryption for a received data message. FIG. 5 illustrates an example record table 500 for storing information regarding SPIs and the VPN gateways that perform encryption for data messages associated with the SPIs. A record table stored at a gateway can include any number of entries for any number of SPIs. A gateway can store a record table in a local storage, a local memory, etc. of the gateway.

The table in this example includes an SPI column 510, an active column 520, an offload column 530, and a gateway column 540. The SPI column 510 specifies the SPI, which identifies the SA. The active column 520 specifies whether the gateway storing the record table 500 is the active gateway, i.e., whether it is the gateway that performs encryption for data messages associated with the SPI. The offload column 530 specifies whether data message encryption for data messages associated with the SPI is offloaded to a different gateway. The gateway column 540 specifies the name and/or identifier of the VPN gateway assigned to perform encryption for data messages associated with the SPI.

For example, for the first record entry in the table 500, the specified SPI is SPI-0. The active column 520 specifies “Yes,” meaning that the gateway storing the table 500 is the gateway that is assigned to perform encryption on data messages associated with SPI-0. The offload column 530 specifies “No,” meaning that encryption for data messages associated with SPI-0 is not offloaded to another gateway. The gateway column 540 specifies an identifier GW-0, which identifies the gateway that stores the table 500. In this example, GW-0 is the default gateway of the datacenter, meaning that the default gateway both establishes the VPN session and encrypts data messages sent along the SA associated with SPI-0.

The second record entry in the table 500 specifies SPI-1. The active column 520 specifies “No,” meaning that the gateway storing the table 500 (i.e., the default gateway) is not the gateway that is assigned to perform encryption on data messages associated with SPI-1. The offload column 530 specifies “Yes,” meaning that encryption for data messages associated with SPI-1 is offloaded to another gateway. The gateway column 540 specifies an identifier GW-1, which identifies a second gateway in the datacenter that is to perform encryption for data messages associated with SPI-1.

Returning back to FIG. 3, at 315, the process 300 receives, from the second VPN gateway, an encrypted data message to be sent along the tunnel to a destination machine in the second datacenter. The encrypted data message is in some embodiments first received as an unencrypted data message at the second VPN gateway from a source machine in the first datacenter that is the source of the unencrypted data message. The source machine provides the unencrypted data message to the second VPN gateway for encryption. After receiving the unencrypted data message, the second VPN gateway determines that it is assigned to perform encryption for this data message. Then, the second VPN gateway encrypts the data message and provides it to the first VPN gateway for forwarding to its destination.

At 320, the process 300 performs a lookup in the first record table to determine that the encrypted data message has been encrypted by the second VPN gateway. The first VPN gateway makes this determination using the first record table and the SPI associated with the data message. After finding an entry in the first record table specifying the second VPN gateway is associated with data messages associated with the same SPI as the encrypted data message, the first VPN gateway knows that the data message has already been encrypted and does not need to be encrypted by the first VPN gateway.

Then, the process 300 forwards (at 325) the encrypted data message to the third VPN gateway of the second datacenter for the third VPN gateway to forward to the destination machine. In some embodiments, the third VPN gateway decrypts the data message before providing it to the destination machine. In other embodiments, the second datacenter also includes a separate, fourth VPN gateway to perform encryption for the third VPN gateway. In such embodiments, the third VPN gateway provides the encrypted data message to the fourth VPN gateway, which decrypts it and provides it to the destination machine. After forwarding the encrypted data message to the second datacenter, the process 300 ends.

In some embodiments, the encrypted data message is a first data message of a particular data message flow. In such embodiments, the process 300 may be performed only for this first data message of the particular data message flow. After the process 300 is performed, the first and second VPN gateways each store the result of their lookup in a connection tracker record stored at the VPN gateway. For subsequent data messages of the particular data message flow, the first and second VPN gateways each can refer to their connection tracker record to determine the action to perform on the data messages (e.g., to encrypt the data messages, to forward the data messages without performing encryption, etc.).

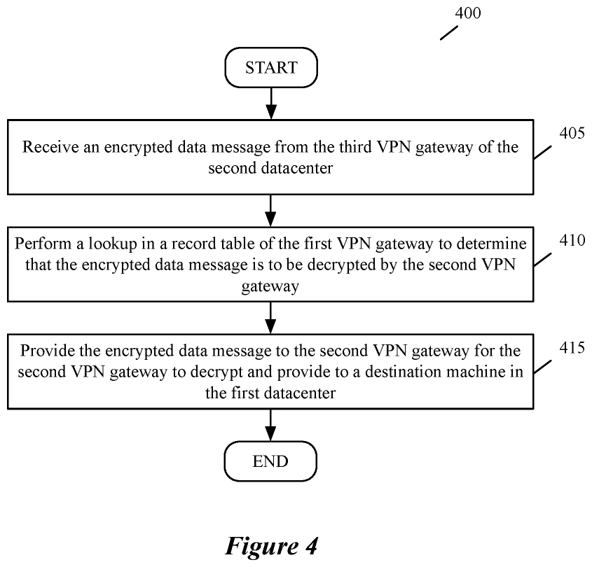

FIG. 4 conceptually illustrates a process of some embodiments for reducing load on the first VPN gateway of the first datacenter by using the second VPN gateway to perform data message decryption needed for VPN communication with the third VPN gateway of the second datacenter. This process 400 is performed by the first VPN gateway for ingress data messages (i.e., data messages entering the first datacenter). In some embodiments, a VPN session is already established with the third VPN gateway and state information is already provided to the second VPN gateway. In other embodiments, similarly to steps 305 and 310, the process 400 first establishes a VPN session and provides state information to the second VPN gateway specifying the second VPN gateway is to perform encryption for a set of data messages exchanged along the tunnel.

At 405, the process 400 receives an encrypted data message from the third VPN gateway of the second datacenter. This encrypted data message originated from a source machine in the second datacenter and is destined for a destination machine in the first datacenter. In some embodiments, the encrypted data message is a response to a data message sent from the first datacenter to the second datacenter (e.g., the encrypted data messages described in FIG. 3). In such embodiments, the destination machine of the process 400 was the source machine of the data message sent from the first datacenter to the second datacenter. In other embodiments, the encrypted data message is unrelated to other encrypted data messages sent along the same SA.

The process 400 performs (at 410) a lookup in a record table of the first VPN gateway to determine that the encrypted data message is to be decrypted by the second VPN gateway. The first VPN gateway makes this determination using its record table storing state information regarding which VPN gateway is assigned to perform encryption and decryption for each SA and the SPI associated with the data message. After finding an entry in the record table specifying the second VPN gateway is associated with data messages associated with the same SPI as the encrypted data message, the first VPN gateway knows that the data message needs to be decrypted by the second VPN gateway.

Then, the process 400 provides (at 415) the encrypted data message to the second VPN gateway for the second VPN gateway to decrypt and provide to a destination machine in the first datacenter. After the second VPN gateway decrypts the data message and the destination machine receives the decrypted data message, the process 400 ends.

In some embodiments, the encrypted data message is a first data message of a particular data message flow. In such embodiments, the process 400 may be performed only for this first data message of the particular data message flow. After the process 400 is performed, the first and second VPN gateways each stores the result of their lookup in a connection tracker record stored at the VPN gateway. For subsequent data messages of the particular data message flow, the first and second VPN gateways each can refer to their connection tracker record to determine the action to perform on the data messages (e.g., to decrypt the data messages, to forward the data messages without performing decryption, etc.).

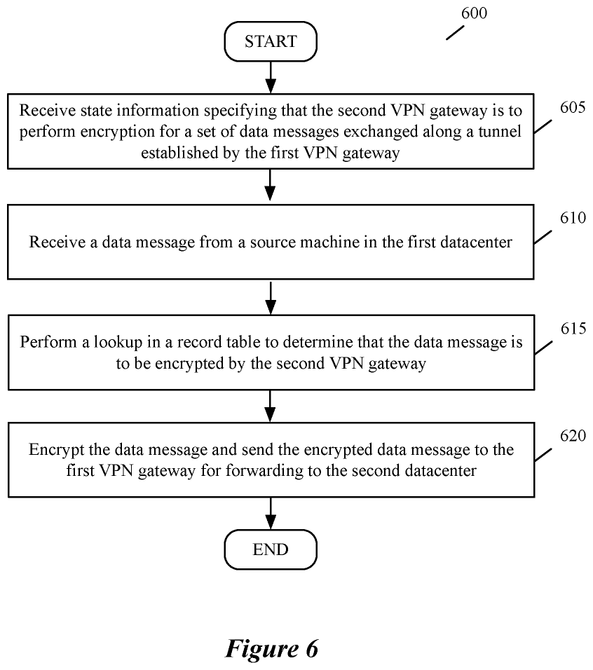

FIG. 6 conceptually illustrates a process 600 of some embodiments for performing data message encryption for a first VPN gateway in a first datacenter that establishes VPN sessions with a second datacenter. This process 600 of some embodiments is performed by a second VPN gateway of the first datacenter that is deployed to offload data message encryption from the first VPN gateway to the second VPN gateway. This process 600 is performed for egress data messages (i.e., data messages exiting the first datacenter). The process 600 begins by receiving (at 605) state information specifying that the second VPN gateway is to perform encryption for a set of data messages exchanged along a tunnel established by the first VPN gateway.

In some embodiments, the second VPN gateway receives, from the first VPN gateway, a record entry that includes a particular SPI identifying a particular SA established by the first VPN gateway and an identifier identifying the second VPN gateway as the VPN gateway that is to perform data message encryption for data messages associated with the SA. An SPI in some embodiments is a unique identifier for the SA. The record entry specifies which VPN gateway (e.g., the second VPN gateway) is to perform data message encryption for data messages specifying the SPI (i.e., for data messages exchanged along the SA). The second VPN gateway in some embodiments stores this record entry in a record table, which may be stored in a local memory or storage of the second VPN gateway.

Next, the process 600 receives (at 610) a data message from a source machine in the first datacenter, and performs (at 615) a lookup in the record table to determine that the data message is to be encrypted by the second VPN gateway. The second VPN gateway uses the state information received from the first VPN gateway to determine which data messages it receives from machines in the first datacenter that it is assigned to encrypt. Using an SPI specified in the data message, the second VPN gateway identifies the SPI in its record table and identifies the gateway (i.e., itself) assigned to perform encryption on data messages associated with that SPI.

Then, the process 600 encrypts (at 620) the data message and sends the encrypted data message to the first VPN gateway for forwarding to the second datacenter. Because the second VPN gateway is only configured to handle encryption, the second VPN gateway provides the encrypted data message to the first VPN gateway in order to be forwarded to its destination in the second datacenter. Then, the process 600 ends.

In some embodiments, the data message is a first data message of a particular data message flow. In such embodiments, the process 600 may be performed only for this first data message of the particular data message flow. After the process 600 is performed, the first and second VPN gateways each stores the result of their lookup in a connection tracker record stored at the VPN gateway. For subsequent data messages of the particular data message flow, the first and second VPN gateways each can refer to their connection tracker record to determine the action to perform on the data messages (e.g., to encrypt the data messages, to forward the data messages without performing encryption, etc.).

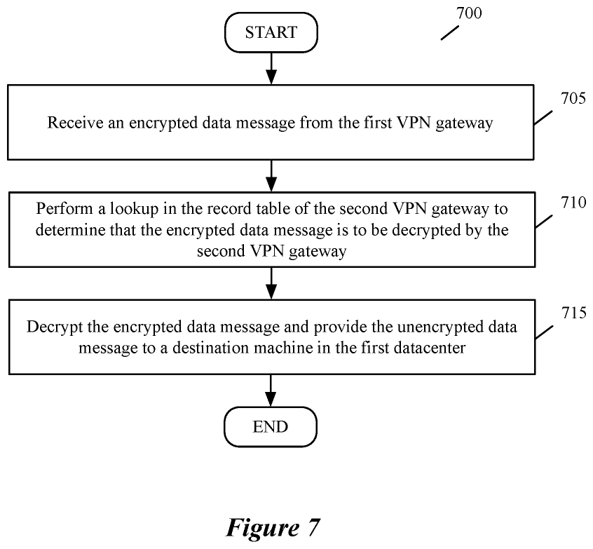

FIG. 7 conceptually illustrates a process 700 of some embodiments for performing data message decryption for a first VPN gateway in a first datacenter that establishes VPN sessions with a second datacenter. This process 700 of some embodiments is performed by a second VPN gateway of the first datacenter that is deployed to offload data message decryption from the first VPN gateway to the second VPN gateway. This process 700 is performed for ingress data messages (i.e., data messages entering the first datacenter). In some embodiments, a VPN session is already established with the third VPN gateway and state information has already been received by the second VPN gateway. In other embodiments, similarly to step 605 of FIG. 6, the process 700 first receives state information specifying that the second VPN gateway is to perform encryption and decryption for a set of data messages exchanged along a tunnel established by the first VPN gateway.

At 705, the process receives an encrypted data message from the first VPN gateway, and performs (at 710) a lookup in a record table to determine that the encrypted data message is to be decrypted by the second VPN gateway. Similarly to step 615 of FIG. 6, the second VPN gateway uses state information received from the first VPN gateway to determine which data messages it receives from the first VPN gateway that it is assigned to decrypt. Using an SPI specified in the received data message, the second VPN gateway identifies the SPI in its record table and identifies the gateway (i.e., itself) assigned to perform encryption and decryption on data messages associated with that SPI.

After determining that the second VPN gateway is assigned to perform encryption and decryption on the received encrypted data message, the process 700 decrypts (at 715) the encrypted data message and provides the unencrypted data message to a destination machine in the first datacenter. After the unencrypted data message has been provided to its destination, the process 700 ends.

In some embodiments, the encrypted data message is a first data message of a particular data message flow. In such embodiments, the process 700 may be performed only for this first data message of the particular data message flow. After the process 700 is performed, the first and second VPN gateways each stores the result of their lookup in a connection tracker record stored at the VPN gateway. For subsequent data messages of the particular data message flow, the first and second VPN gateways each can refer to their connection tracker record to determine the action to perform on the data messages (e.g., to decrypt the data messages, to forward the data messages without performing decryption, etc.).

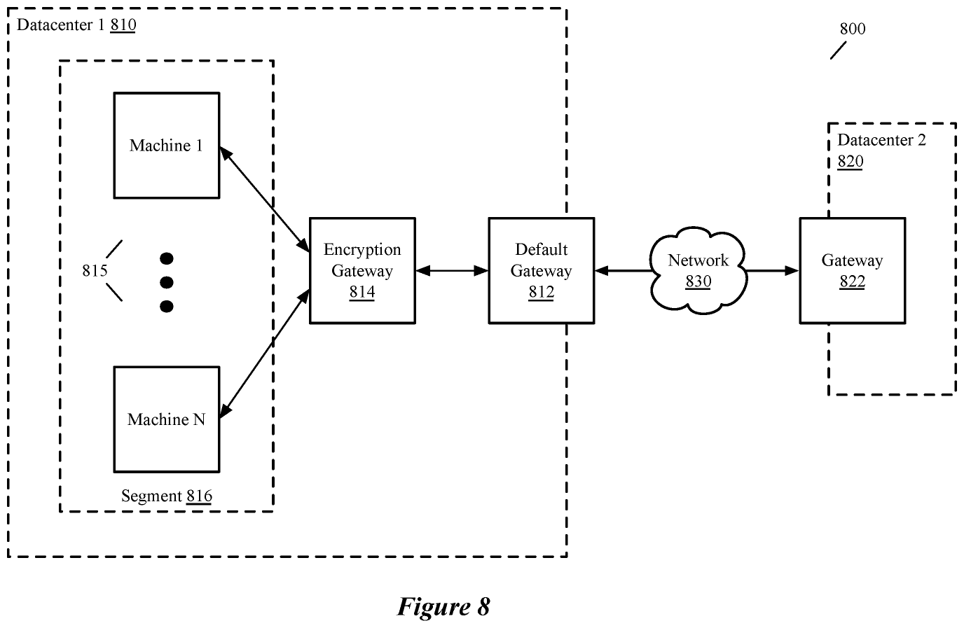

FIG. 8 illustrates an example system 800 for a first datacenter 810 to communicate with a second datacenter 820. The datacenter 810 includes a default gateway 812 that forwards all data messages that enter and exit the datacenter 810. The default gateway 812 also establishes VPN sessions with the gateway 822 of the second datacenter 820 through a network 830. In some embodiments, the gateway 822 of the second datacenter 820 is the only gateway of the second datacenter 820 that performs VPN session establishment and encryption. In other embodiments, the second datacenter 820 includes one or more other gateways that perform VPN encryption for the gateway 822.

The first datacenter 810 includes an encryption gateway 814 that performs data message encryption on data messages exchanged with the second datacenter 820 during a VPN session established by the default gateway 812. In this example, the encryption gateway 814 performs encryption for all data messages. The first datacenter 810 also includes a set of one or more machines 815 that are the sources and destinations of traffic for the datacenter 810. The machines 815 may include any one or more of VMs, containers, pods, etc. These machines 815 in some embodiments represent a logical segment 816 (also referred to as a segment or a prefix) of the first datacenter 810. There may be any number of machines 815 executing on any number of host computers in this segment 816.

In some embodiments, the set of machines 815 of the segment 816 includes all machines of the first datacenter 810. In other embodiments, the set of machines 815 of the segment 816 includes a subset of machines of the first datacenter 810. In such embodiments, the other machines in the first datacenter 810 do not use the encryption gateway 814 for data message encryption. For instance, they may use the default gateway 812, or they may not be associated with any VPN sessions that require data message encryption.

In this example, all data messages exchanged between the machines 815 and machines in the second datacenter 820 are encrypted and decrypted by the encryption gateway 814 and are exchanged with the second datacenter using the default gateway 812. The encryption gateway 814 may operate on a separate host than the machines 815, or may be a separate hardware appliance of the first datacenter 810.

For egress traffic (i.e., for traffic leaving the datacenter 810), a machine of the set of machines 815 that is the source of a data message sends the data message to the encryption gateway 814. The encryption gateway 814 receives the data message and uses a stored record table (such as the record table 500 of FIG. 5) to match the SPI specified in the data message to the gateway that is to perform encryption for the data message. In some embodiments, the SPI identifies the SA along which the data message is to be exchanged, and a particular gateway is assigned to perform encryption on data messages for that SA.

In this example, the encryption gateway 814 determines from the record table that itself is to perform the encryption, and the encryption gateway 814 encrypts the data message and forwards the encrypted data message to the default gateway 812. After receiving an encrypted data message, the default gateway 812 performs a lookup in its own record table to determine that the encrypted gateway 814 is assigned to perform encryption for this data message. Then, the default gateway 812 forwards the encrypted data message through the network 830 along the SA (e.g., along the IPsec tunnel) to the second datacenter's gateway 822 for it to be decrypted and delivered to its destination at the second datacenter 820.

For ingress traffic (i.e., for data messages entering the datacenter 810), the default gateway 812 receives an encrypted data message from the gateway 822 to be sent to a destination machine of the set of machines 815. The default gateway 812 uses its record table to determine which gateway in the datacenter 810 is to perform decryption. When the default gateway 812 determines that the encryption gateway 814 is to perform the decryption, the default gateway 812 provides the encrypted data message to the encryption gateway 814, which decrypts the data message and forwards it to the destination machine.

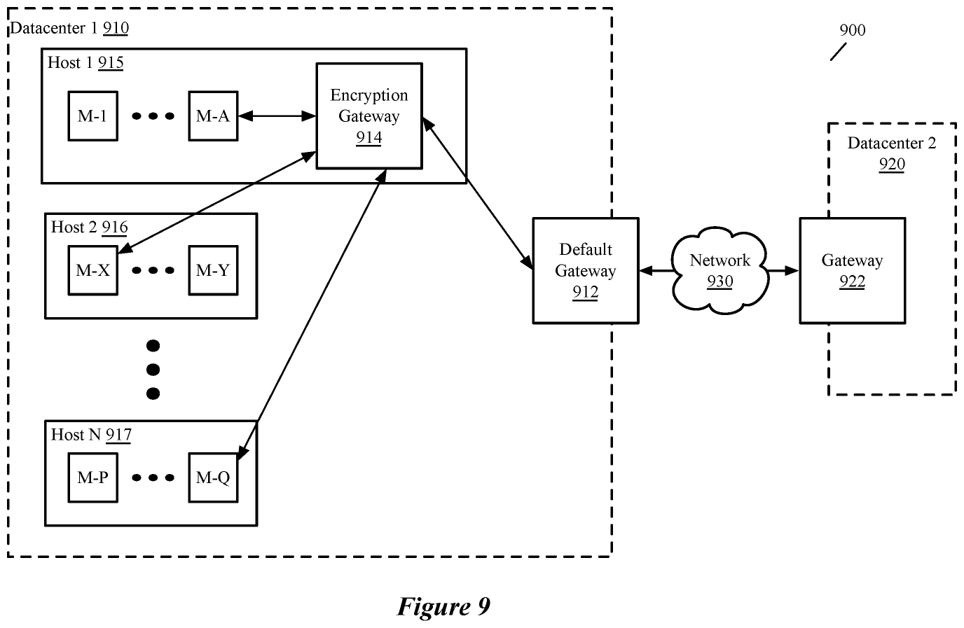

FIG. 9 illustrates another example system 900 for a first datacenter 910 to communicate with a second datacenter 920. The datacenter 910 includes a default gateway 912 that forwards all data messages that enter and exit the datacenter 910. The default gateway 912 also establishes VPN sessions with the gateway 922 of the second datacenter 920 through a network 930. In some embodiments, the gateway 922 of the second datacenter 920 is the only gateway of the second datacenter 920 that performs VPN session establishment and encryption. In other embodiments, the second datacenter 920 includes one or more other gateways that perform VPN encryption for the gateway 922.

In this example, an encryption gateway 914 executes on a first host 915 and encrypts data messages sent to and from at least a subset of machines executing on the first host 915 and at least a subset of other machines executing on other hosts 916 and 917 of the first datacenter 910. While the encryption gateway 914 executes on a host 915 along with machines that are sources and destinations of data messages exchanged for one or more VPN sessions established by the default gateway 912, the encryption gateway 914 provides encryption for the other machines on the other hosts 916 and 917 in the datacenter 910. Some machines on the hosts 915-917 may instead use the default gateway 912 for data message encryption, or may not be associated with VPN sessions requiring data message encryption.

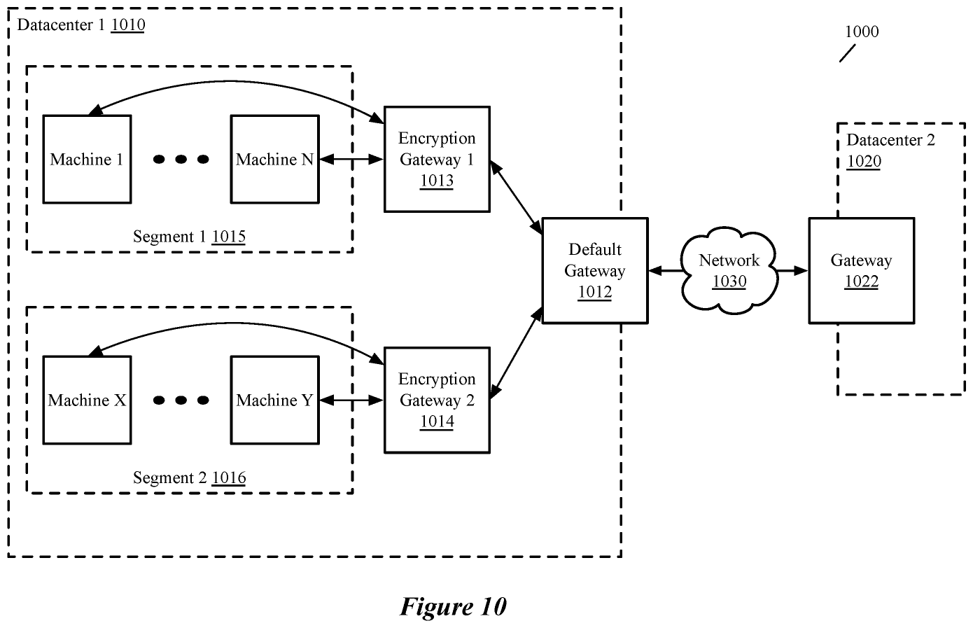

FIG. 10 illustrates another example system 1000 for a first datacenter 1010 to communicate with a second datacenter 1020. The datacenter 1010 includes a default gateway 1012 that forwards all data messages that enter and exit the datacenter 1010. The default gateway 1012 also establishes VPN sessions with the gateway 1022 of the second datacenter 1020 through a network 1030. In some embodiments, the gateway 1022 of the second datacenter 1020 is the only gateway of the second datacenter 1020 that performs VPN session establishment and encryption. In other embodiments, the second datacenter 1020 includes one or more other gateways that perform VPN encryption for the gateway 1022.

In this example, the first datacenter 1010 includes two encryption gateways 1013 and 1014 for performing at least some data message encryption operations for the default gateway 1012. A first encryption gateway 1013 performs encryption for a first segment 1015 including a first set of machines of the first datacenter 1010, and a second encryption gateway 1014 performs encryption for a second segment 1016 including a second set of machines of the first datacenter 1010. In some embodiments, each segment 1015 and 1016 includes machines executing on one or more host computers in the first datacenter 1010. For example, the first segment 1015 can include machines executing on a first set of host computers, and the second segment 1016 may include machines including a second set of host computers. The first and second sets of host computers may include at least one same host computer, meaning that two machines on the same host computer can be assigned to different segments 1015 and 1016.

In some embodiments, the machines in segments 1015 and 1016 include all machines of the first datacenter 1010. In other embodiments, a subset of machines of the first datacenter 1010 are not included in either segment. In such embodiments, the subset of machines may use the default gateway 1012 for data message encryption operations, use another gateway in the first datacenter 1010 for data message encryption operations, or may not be associated with any VPN sessions that require data message encryption.

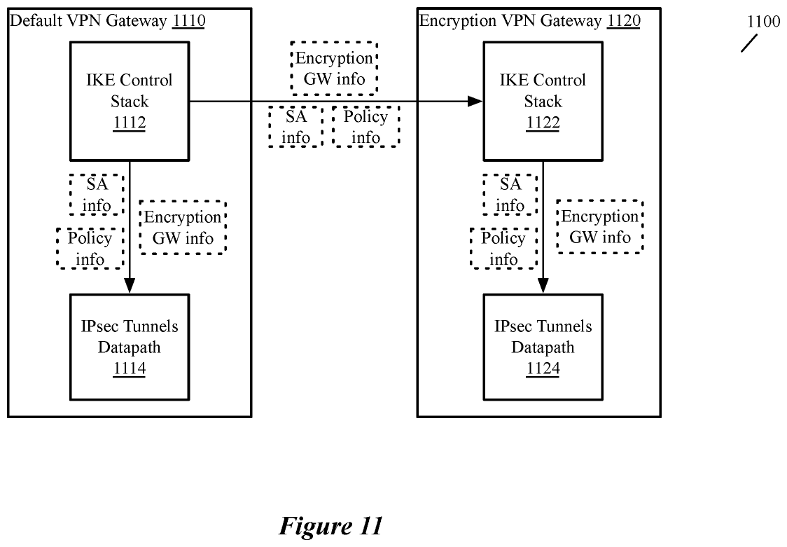

As discussed previously, an encryption gateway can perform encryption for data messages exchanged during a VPN session established by a default gateway. FIG. 11 illustrates a block diagram of a system 1100 that is implemented for gateways or edge appliances of a datacenter in some embodiments to perform establishment of a VPN session and encryption for data messages exchanged for that VPN session. This system includes two gateways, a default VPN gateway 1110 that establishes the VPN session and an encryption VPN gateway 1120 that performs encryption for the VPN session. In some embodiments, the default VPN gateway 1110 performs encryption for at least a subset of data messages of a VPN session along with the encryption VPN gateway 1120. In other embodiments, the encryption VPN gateway 1120 performs encryption for all of the data messages of one or more VPN sessions, while the default VPN gateway 1110 establishes the VPN sessions and exchanges the encrypted data messages along the IPsec tunnel of the VPN sessions.

The system 1100 may be implemented by bare metal computing devices or host machines running virtualization software that operate the gateways in one or more virtual machines. In some embodiments, the system 1100 represents a VPN control plane. Also, in some embodiments, the system 1100 is utilized by the initiator (i.e., source) of a communications session, while in other embodiments, both the initiator and responder (i.e., destination) utilize the system 1100.

As illustrated, each gateway 1110 and 1120 implements an IKE control stack 1112 and 1122 and IPsec tunnels datapath 1114 and 1124. In some embodiments, the IKE control stacks 1112 and 1122 are submodules of the VPN control plane, while the IPsec tunnels datapaths 1114 and 1124 represent the VPN data plane. In some embodiments, the modules 1112, 1114, 1122, and 1124 are modules of software instructions being executed by one or more processing units (e.g., a processor) of one or more computing devices. In some embodiments, the modules 1112, 1114, 1122, and 1124 are modules of hardware circuits implemented by one or more integrated circuits (ICs) of one or more electronic apparatuses. Though the modules 1112, 1114, 1122, and 1124 are illustrated as being separate modules, some of the modules can be combined into a single module per gateway 1110 and 1120.

The IKE control stack 1112 of the default VPN gateway 1110 controls the operations of IPsec, including establishing and maintaining VPN sessions and SAs. The IKE control stack 1112 provides the necessary key data to IPsec tunnels datapath 1114 for authenticating and encrypting payloads (e.g., SA information, policy information, and encryption gateway information) of data messages that are to be encrypted by the default VPN gateway 1110, and for determining which data messages are to be encrypted by the encryption gateway 1120.

The IKE control stack 1112 also provides the necessary key data to the IKE control stack 1122 of the encryption VPN gateway 1120 to sync this information between the two gateways 1110 and 1120. Since the encryption VPN gateway 1120 does not establish VPN sessions, the default VPN gateway 1110 syncs information with the encryption VPN gateway 1120 for it to know which data messages it is assigned to encrypt. The IKE control stack 1122 of the encryption gateway 1120 provides the necessary key data to IPsec tunnels datapath 1124 for authenticating and encrypting payloads of data messages that are to be encrypted by the encryption VPN gateway 1120. In some embodiments, this syncing of information is managed by the management plane (not shown) of the system 1100.

In some embodiments, The IPsec tunnels datapaths 1114 and 1124 include various VPN data plane modules. The IPsec tunnels datapaths 1114 and 1124 also perform encryption and authentication of payloads based on the SA information provided by the IKE control stacks 1112 and 1122. In some embodiments, an encryption module of an IPsec tunnels datapath encrypts the inner packet of a data message into an IPsec encrypted packet according to the encryption parameters of the SA information and the policy information provided by the IKE control stack. The encryption module may also append other IPsec related fields based on the SA information (e.g., encapsulating security payload (ESP) header, ESP trailer, ESP authentication, new IP, etc.). An encapsulation module of the IPsec tunnel datapath in some embodiments encapsulates the IPsec encrypted packet with an encapsulation header, which may include an SPI associated with the SA. A data plane routing module of the IPsec tunnels datapath then sends the encapsulated packet to the default gateway of the datacenter for forwarding.

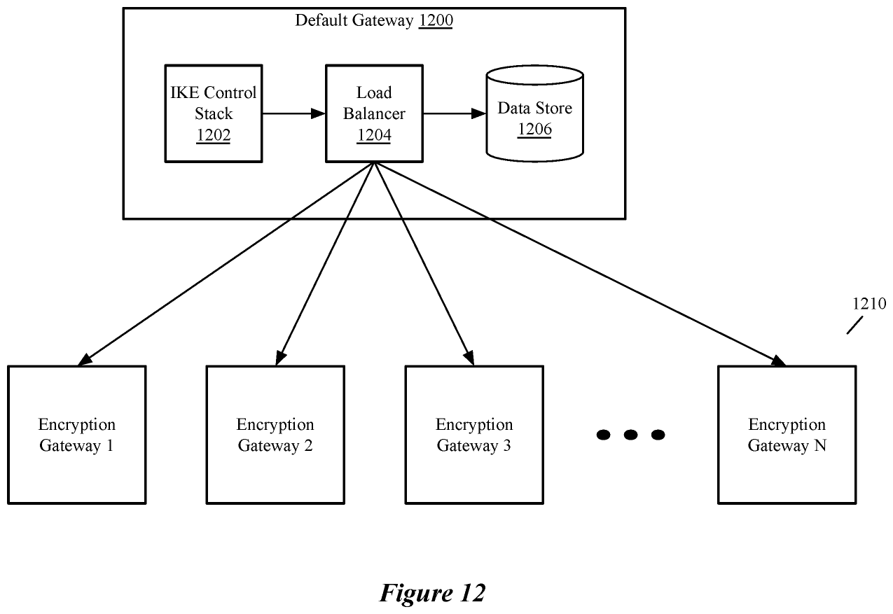

As discussed previously, multiple encryption gateways can be deployed in a datacenter for offloading data message encryption for a default gateway of the datacenter, and the default gateway can perform load balancing operations to distribute encryption processes to the multiple encryption gateways. FIG. 12 illustrates a default gateway 1200 that load balances encryption processes for VPN communications to a set of encryption gateways 1210 operating in the same datacenter. Any number of encryption gateways 1210 may be deployed to perform data message encryption for the default gateway 1200.

The default gateway 1200 includes an IKE control stack 1202 that is configured to establish and maintain VPN sessions and SAs with one or more other datacenters. After establishing an SA, the IKE control stack 1202 provides the SA information to the gateway's load balancer 1204. The load balancer 1204 is a module of the default gateway 1200 that performs load balancing operations to distribute encryption processes among the encryption gateway 1210. In some embodiments, the load balancer 1204 evenly distributes encryption processes among the encryption gateways 1210. In other embodiments, the load balancer 1204 assigns different amounts of SAs to each encryption gateway 1204, which can be based on policies received from a network administrator.

After receiving information about an established SA, the load balancer 1204 assigns one of the encryption gateway 1210 to the SA such that the assigned gateway performs data message encryption for the data messages exchanged along that SA. The load balancer 1204 distributes this information to each of the encryption gateways 1210 for each encryption gateway to store in its own record table. The load balancer 1204 also provides this information to a data store 1206 of the default gateway 1200 so the default gateway 1200 can refer to the data store 1200 and provide data messages it receives along the SA to the correct encryption gateway 1210. In some embodiments, each encryption gateway in the set 1210 receives all state information from the default gateway 1200, including state information not associated with it. In other embodiments, each encryption gateway only receives state information from the default gateway 1200 related to itself. In these embodiments, each encryption gateway receives only the relevant policies needed for the specific encryption processes it performs.

In some embodiments, a default gateway can reallocate a particular SA from one gateway to another. For example, the default gateway 1200 may first allocate a particular SA to a first encryption gateway of the encryption gateway set 1210. The default gateway 1200 can reallocate the particular SA to a second encryption gateway of the set 1210. This may occur when the machines associated with the first encryption gateway are reassigned to the second VPN gateway due to a change in the policy of the VPN session.

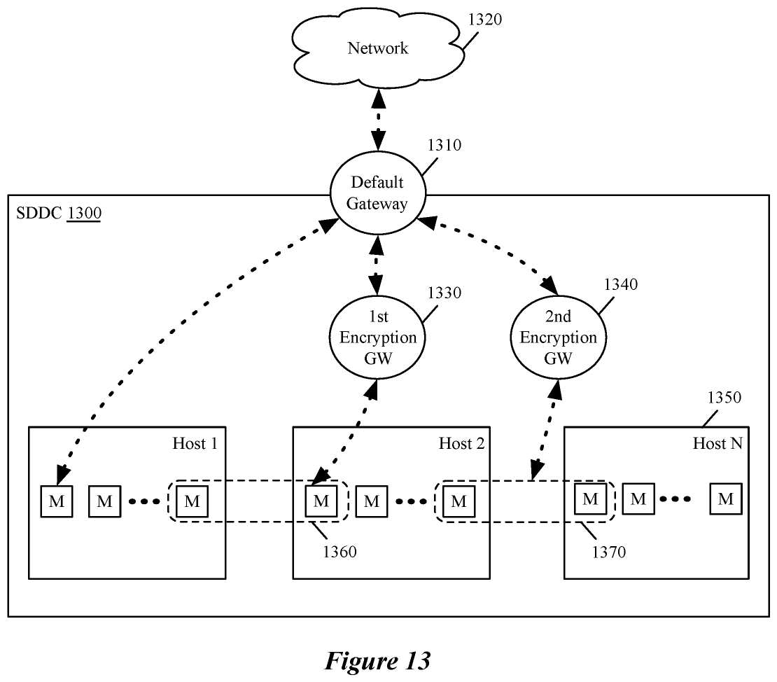

In some embodiments, gateways of a datacenter can perform data message encryption for data messages associated with a particular traffic group in the datacenter. Traffic groups may also be referred to as segments. FIG. 13 illustrates an SDDC 1300 that performs data message encryption at different gateways for different traffic groups. The SDDC 1300 includes a default gateway 1310 that communicates with an external network 1320. In some embodiments, the default gateway 1310 communicates with another SDDC (not shown) through the network 1320 using secure communication channels (e.g., VPN and IPsec tunnels). The SDDC 1300 also deploys additional encryption gateways 1330 and 1340 that perform some data message encryption for VPN sessions established by the default gateway 1310.

The encryption gateways 1330 and 1340 are created in the SDDC 1300 for different traffic groups of machines executing on hosts 1350 in the SDDC 1300. A first traffic group includes a set of machines 1360 for which its data messages are encrypted by the first encryption gateway 1330. A second traffic group includes a set of machines 1370 for which its data messages are encrypted by the second encryption gateway 1340. Machines not assigned to a traffic group are assigned to the default gateway 1310. In this example, the default gateway 1310 performs data message encryption for a subset of the data messages exchanged with the network 1320, i.e., for data messages exchanged with machines in the SDDC 1300 not assigned to a traffic group. Performing some data message encryption at encryption gateways 1330 and 1340 may be performed to alleviate the load on the default gateway 1310. In other embodiments, all data message encryption is performed by additional encryption gateways.

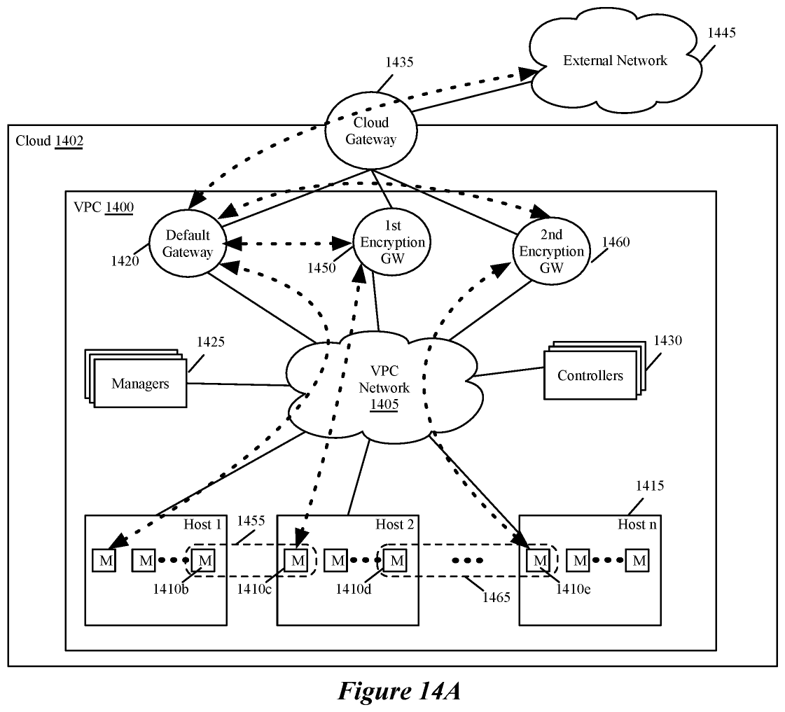

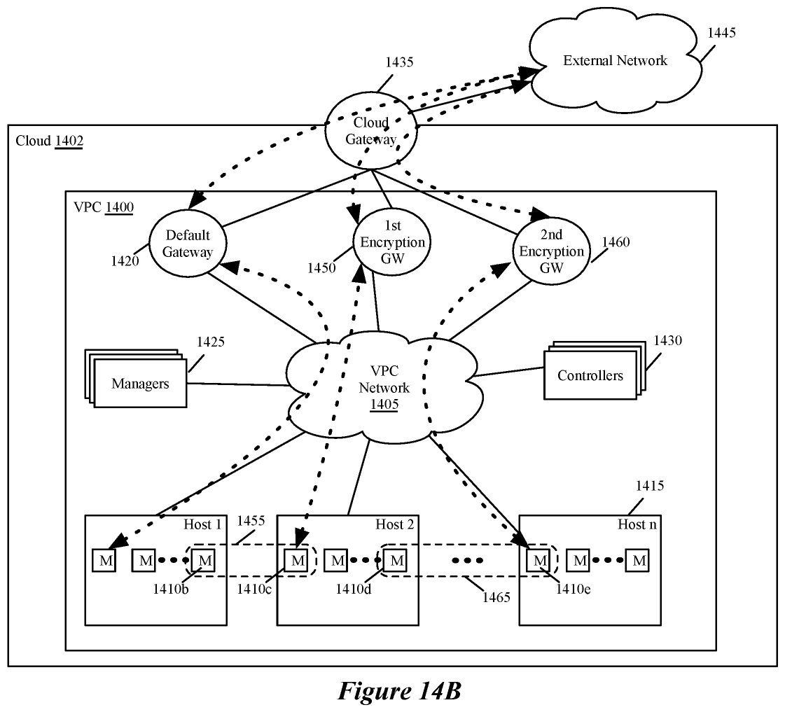

FIGS. 14A-B illustrate an example SDDC that is a public cloud availability zone 1402 in which a virtual private cloud (VPC) 1400 has been defined for an entity, which in this example is a tenant of the private cloud. An availability zone in some embodiments includes one datacenter or more than one datacenters that are near each other. Although FIGS. 14A-B illustrate the use of some embodiments in a public cloud context, one of ordinary skill will realize that some embodiments of the invention can similarly be implemented in private datacenters.

For the entity, the VPC 1400 includes a private network 1405 formed by several forwarding elements (e.g., switches and routers), which are not shown in these figures to avoid obscuring these figures with unnecessary detail. The forwarding elements include software forwarding elements (e.g., software switches and/or routers) and middlebox elements (e.g., firewall, load balancers, etc.) executing on multi-tenant host computers 1415 along with machines 1410 that have been deployed for the entity. In some embodiments, the forwarding elements also include hardware forwarding elements and/or middlebox elements (e.g., hardware switching and/or router appliances, and/or middlebox appliances).

In some embodiments, the private network 1405 is established by sharding the internal network address space of the private cloud, and providing a set of internal network addresses to the private network 1405 that does not overlap with the internal network addresses provided to any other tenant of the VPC. In other embodiments, the private network 1405 is a logical overlay network that is formed by establishing tunnels between the forwarding elements of the private network and having the forwarding elements exchange data messages through these tunnels, e.g., by encapsulating the data messages with tunnel headers that allow the data messages to be exchanged between the forwarding elements, while preserving the original data message headers that contain network addresses defined in the logical address space. In some embodiments, the logical address space of one tenant might overlap with the logical address space of another tenant but this does not matter because of the encapsulating tunnel headers.

A default gateway 1420 is initially deployed by a set of controllers 1430, managed by a set of managers 1425, to connect the VPC network 1405 with an external network. In this example, any VPC gateway (including the default gateway 1420) connects to (i.e., forwards packets to) one or more gateways 1435 of the public cloud datacenter 1402, which communicates with an external network 1445 outside of the public cloud datacenter 1402. In other embodiments, a VPC gateway (including the default gateway 1420) connects directly to the external network 1445 without having to go through any gateway 1435 of the public cloud datacenter 1402.

In some embodiments, the controller set 1430 configures the default gateway 1420 to forward ingress data messages to the VPC network from the cloud gateway 1435, and egress data messages from the VPC network to the cloud gateway 1435. The controller set in some embodiments also configures the forwarding elements in the VPC network 1405 to forward the egress data message to the default gateway 1420, and the ingress data messages to the machines 1410 of the VPC network. In the example of FIG. 14A the default gateway 1420 is the gateway that establishes VPN sessions with the external network 1445 or with other datacenters across the external network 1445.

A first encryption gateway 1450 has been created in the VPC 1400 for a first traffic group. This traffic group includes a set of machines 1455, including machines 1410b and 1410c.

Because the default gateway 1420 establishes VPN sessions, ingress data messages to the first traffic group (i.e., all the data messages that are destined to the list of network addresses provided for the first traffic group) are forwarded from the cloud gateway 1435 to the default gateway 1420. The default gateway 1420 then forwards the ingress data messages to the first encryption gateway 1450 for decryption and for providing to their destinations. Egress data messages sent from the first traffic group (i.e., all the data messages that are sent from the list of network addresses provided for the first traffic group) are initially forwarded to the first encryption gateway 1450, which encrypts the data messages and forwards the encrypted data messages to the default gateway 1420. The default gateway 1420 then forwards the data messages to the cloud gateway to be sent to the external network 1445.

More specifically, the controller set 1430 configures the default gateway 1420 to forward to the first encryption gateway 1450 ingress data messages that are destinated to the network address provided for the first traffic group. The controller set 1430 also configures the first encryption gateway 1450 to forward these ingress data messages to the VPC network 1405 from the default gateway 1420, and egress data messages from the first traffic group machines 1455 to the default gateway 1420. In some embodiments, the controller servers also configure the first encryption gateway 1450 to advertise routes to the list of traffic group-associated network addresses to the default gateway 1420. The controller set 1430 in some embodiments also configures the forwarding elements in the VPC network 1405 to forward the egress data message with source addresses in the provided list of address of the first traffic group (i.e., all the egress data messages from the set of machines 1455 of the first traffic group) to the first encryption gateway 1450. It also configures these forwarding elements to forward the ingress data messages that are destined to the traffic group-associated network addresses to the machine set 1455. In some embodiments, the encryption gateway 1450 also performs services (e.g., firewall, load balancing, network address translation (NAT), etc.) on the data messages associated with the first traffic group machines 1455.

The forwarding elements in the VPC network 1405 in some embodiments include intervening routers. The controller set 1430 configures these intervening routers in the VPC network 1405 in some embodiments by providing next-hop forwarding rules to the set of intervening routers. Alternatively, or conjunctively, the configured set of forwarding elements in some embodiments includes a set of intervening switches that implement a logical switch. In these embodiments, the method configures the set of intervening switches by providing forwarding rules to the set of intervening switches to direct the switches to forward the first set of data message flows to the first encryption gateway 1450 through tunnels that connect the set of intervening switches to the first encryption gateway 1450.

A second encryption gateway 1460 has been created in the VPC 1400 for a second traffic group. This traffic group includes a set of machines 1465, including machines 1410d and 1410e. For the second traffic group, the controller set 1430 deploys the second encryption gateway 1460. As it did for the first traffic group, the controller set 1430 configures the default gateway 1420 to forward to the second encryption gateway 1460 ingress data messages that are destinated to the network address provided for the second traffic group. The controller set 1430 also configures the second encryption gateway 1460 to forward these ingress data messages to the VPC network 1405 from the default gateway 1420, and egress data messages from the second traffic group machines 1465 to the default gateway 1420.

In some embodiments, the controller servers also configure the second encryption gateway 1460 to advertise routes to the list of traffic group-associated network addresses to the default gateway 1420. The controller set 1430 in some embodiments also configures the forwarding elements in the VPC network 1405 to forward the egress data message with source addresses in the provided list of address of the second traffic group (i.e., all the egress data messages from the set of machines 1465 of the first traffic group) to the second encryption gateway 1460. It also configures these forwarding elements to forward the ingress data messages that are destined to the traffic group-associated network addresses to the machine set 1465. In some embodiments, the second encryption gateway 1460 also performs services (e.g., firewall, load balancing, network address translation (NAT), etc.) on the data messages associated with the second traffic group machines 1465.

After the controller set 1430 configures the first and second encryption gateways 1450 and 1460, the first gateway 1450 forwards all of the ingress and egress traffic for the first traffic group machines to the default gateway 1420, the second gateway 1460 forwards all of the ingress and egress traffic for the second traffic group machines to the default gateway 1420, and the default gateway 1420 forwards all of the ingress and egress traffic for the VPC 1400 to the cloud gateway 1435.

FIG. 14B illustrates the example SDDC that is a public cloud availability zone 1402 in which the VPC 1400 has been defined for the entity, which in this example is a tenant of the private cloud. However, in this example, the cloud gateway 1435 is the gateway that establishes VPN sessions with the external network 1445 or with other datacenters across the external network 1445.

In this example, the default gateway 1420 is a default encryption gateway created in the VPC to perform encryption for data messages associated with machines not in a traffic group. Because the cloud gateway 1435 establishes VPN sessions, ingress data messages to machines not in a traffic group are forwarded from the cloud gateway 1435 to the default encryption gateway 1420. Egress data messages sent from machines not in a traffic group are initially forwarded to the default encryption gateway 1420, which encrypts the data messages and forwards the encrypted data messages to the cloud gateway 1435. The cloud gateway 1435 then forwards the data messages to the external network 1445.

The first encryption gateway 1450 in the VPC 1400 is assigned the first traffic group including machines 1455. Because the cloud gateway 1435 establishes VPN sessions, ingress data messages to the first traffic group (i.e., all the data messages that are destined to the list of network addresses provided for the first traffic group) are forwarded from the cloud gateway 1435 to the first encryption gateway 1450. Egress data messages sent from the first traffic group (i.e., all the data messages that are sent from the list of network addresses provided for the first traffic group) are initially forwarded to the first encryption gateway 1450, which encrypts the data messages and forwards the encrypted data messages to the cloud gateway 1435. The cloud gateway 1435 then forwards the data messages to the external network 1445.

In some of these embodiments, the controller set 1430 employs destination-side routing to ensure that the cloud gateway 1435 forwards all of the ingress data messages to the first traffic group (i.e., all the data messages that are destined to the list of network addresses provided for the first traffic group) to the first encryption gateway 1450, and source-side routing to ensure that the forwarding elements of the VPC network 1405 forward all the egress data messages from the first traffic group (i.e., all the egress data messages from the list of network addresses provided by the first traffic group) to the first encryption gateway 1450.

More specifically, the controller set 1430 configures the cloud gateway 1435 to forward to the first encryption gateway 1450 ingress data messages that are destinated to the network address provided for the first traffic group. The controller set 1430 also configures the first encryption gateway 1450 to forward these ingress data messages to the VPC network 1405 from the cloud gateway 1435, and egress data messages from the first traffic group machines 1455 to the cloud gateway 1435. In some embodiments, the controller servers also configure the first encryption gateway 1450 to advertise routes to the list of traffic group-associated network addresses to the cloud gateway 1435. The controller set 1430 in some embodiments also configures the forwarding elements in the VPC network 1405 to forward the egress data message with source addresses in the provided list of address of the first traffic group (i.e., all the egress data messages from the set of machines 1455 of the first traffic group) to the first encryption gateway 1450. It also configures these forwarding elements to forward the ingress data messages that are destined to the traffic group-associated network addresses to the machine set 1455.

The second encryption gateway 1460 in the VPC 1400 is assigned the second traffic group including machines 1465. Because the cloud gateway 1435 establishes VPN sessions, ingress data messages to the second traffic group (i.e., all the data messages that are destined to the list of network addresses provided for the second traffic group) are forwarded from the cloud gateway 1435 to the second encryption gateway 1460. Egress data messages sent from the second traffic group (i.e., all the data messages that are sent from the list of network addresses provided for the second traffic group) are initially forwarded to the second encryption gateway 1460, which encrypts the data messages and forwards the encrypted data messages to the cloud gateway 1435. The cloud gateway 1435 then forwards the data messages to the external network 1445.

As it did for the first traffic group, the controller set employs destination-side routing to ensure that the cloud gateway 1435 forwards all of the ingress data messages to the second traffic group (i.e., all the data messages that are destined to the list of network addresses provided for the second traffic group) to the second encryption gateway 1460, and source-side routing to ensure that the forwarding elements of the VPC network 1405 forward all the egress data messages from the second traffic group (i.e., all the egress data messages from the list of network addresses provided by the second traffic group) to the second encryption gateway 1460.

The controller set 1430 also configures the second encryption gateway 1460 to forward the ingress data messages to the VPC network 1405 from the cloud gateway 1435, and egress data messages from the second traffic group machines 1465 to the cloud gateway 1435. In some embodiments, the controller set also configures the second encryption gateway 1460 to advertise routes to the network addresses associated with the second traffic group to the cloud gateway 1435. The controller set 1430 in some embodiments also configures the forwarding elements in the VPC network 1405 to forward ingress data messages that are destined to the second traffic group-associated network addresses to the machine set 1465.

After the controller set 1430 configures the default, first, and second encryption gateways 1420, 1450, and 1460, the first gateway 1450 forwards all of the ingress and egress traffic for the first traffic group machines, the second gateway 1460 forwards all of the ingress and egress traffic for the second traffic group machines, and the default gateway 1420 forwards all of the ingress and egress traffic for entity machines that are not in the first and second traffic groups.

In some embodiments, each gateway 1420, 1450, or 1460 is a logical gateway that is implemented by a high-availability (HA) pair of physical gateways, which are in an HA active-standby configuration. Also, each gateway is deployed as a separate appliance in some embodiments. In other embodiments, each gateway is deployed as a machine that executes on a host computer (e.g., a multi-tenant host computer or a standalone host computer). In some of these embodiments, the different gateways are deployed on different host computers in order to maximize the throughput of each gateway. Using different host computers to implement different gateways for different traffic groups allows dedicated resources (e.g., physical network interface cards (PNICs)) of the different host computers to be used for the data message flows of the different traffic groups.

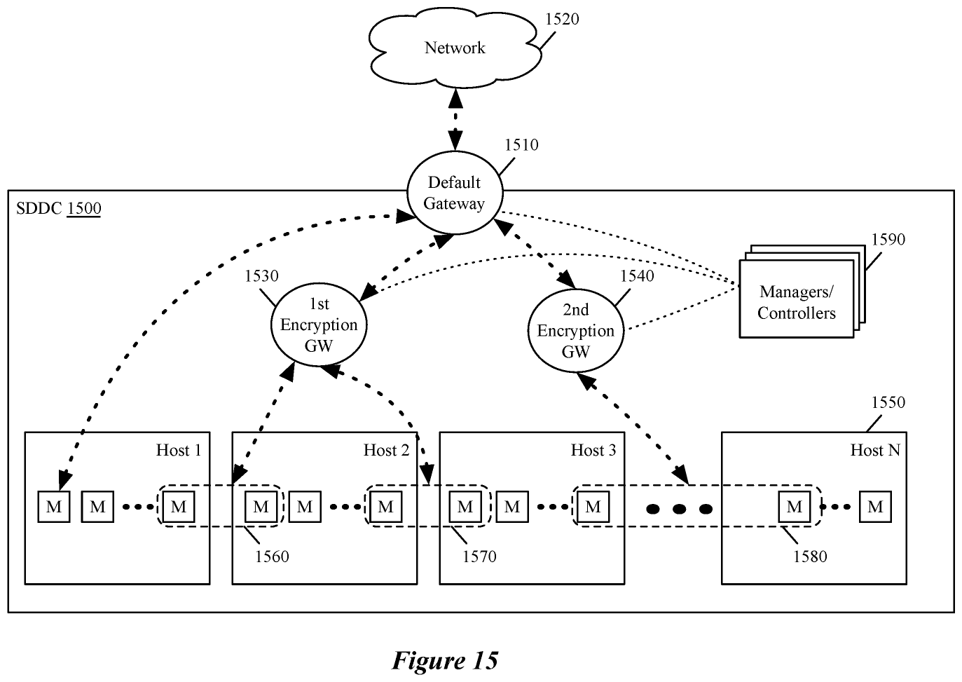

In some embodiments, one encryption gateway is assigned two or more traffic groups or segments (i.e., two or more sets of machines). FIG. 15 illustrates another example SDDC 1500 that performs data message encryption at different gateways for different segments. The SDDC 1500 includes a default gateway 1510 that communicates with an external network 1520. In some embodiments, the default gateway 1510 communicates with another SDDC (not shown) through the network 1520 using secure communication channels (e.g., VPN and IPsec tunnels). The SDDC 1500 also deploys additional encryption gateways 1530 and 1540 that perform some data message encryption for VPN sessions established by the default gateway 1510.

The encryption gateways 1530 and 1540 are created in the SDDC 1500 for different segments (also referred to as traffic groups) of machines executing on hosts 1550 in the SDDC 1500. A first segment includes a set of machines 1560 for which its data messages are encrypted by the first encryption gateway 1530. A second segment includes a set of machines 1570 for which its data messages are also encrypted by the first encryption gateway 1530. A third segment includes a set of machines 1580 for which its data messages are encrypted by the second encryption gateway 1540. Machines not assigned to a segment are assigned to the default gateway 1510, i.e., the default gateway 1510 performs data message encryption for a subset of the data messages associated with machines in the SDDC 1500 not assigned to a segment. Performing some data message encryption at encryption gateways 1530 and 1540 may be performed to alleviate the load on the default gateway 1510. In other embodiments, all data message encryption is performed by additional encryption gateways.

In some embodiments, segments are specified in a VPN policy defined by a user. A user may define a VPN policy for a particular segment using an Application Programming Interface (API) or through a graphical user interface (GUI). The API or the specification in the GUI is received at a set of one or more managers and controllers 1590 (specifically a manager) of the datacenter and provided to the default gateway 1510 of the SDDC 1500. Using the VPN policy, the default gateway 1510 establishes the VPN session (i.e., it negotiates the IPsec SA and negotiates the key for the SA).

The default gateway 1510 of some embodiments has a record table specifying which segments of the SDDC 1500 are to be assigned to which gateway (e.g., the default gateway 1510 or one of the encryption gateways 1530 or 1540) for encryption. In some embodiments, this table is maintained by the manager and controller set 1590 (specifically a controller) of the SDDC 1500 that assigns segments of the SDDC to one or more gateways (including the default gateway) that perform VPN encryption. Using this record table, the default gateway 1510 can perform a lookup to determine which gateway is associated with the segment specified in the VPN policy. Then, the default gateway 1510 can assign the SA established for the VPN session to the gateway associated with the segment.

In some embodiments, a default gateway itself is assigned the segment, so the default gateway assigns the SA to itself to perform encryption for data messages exchanged along this SA. In other embodiments, when an additional gateway in the datacenter is assigned the segment, the default gateway assigns the SA to the additional gateway and creates a channel between itself and the additional gateway to sync the established key information. Then, the additional gateway can perform encryption for data messages associated with machines in the segment specified in the VPN policy.

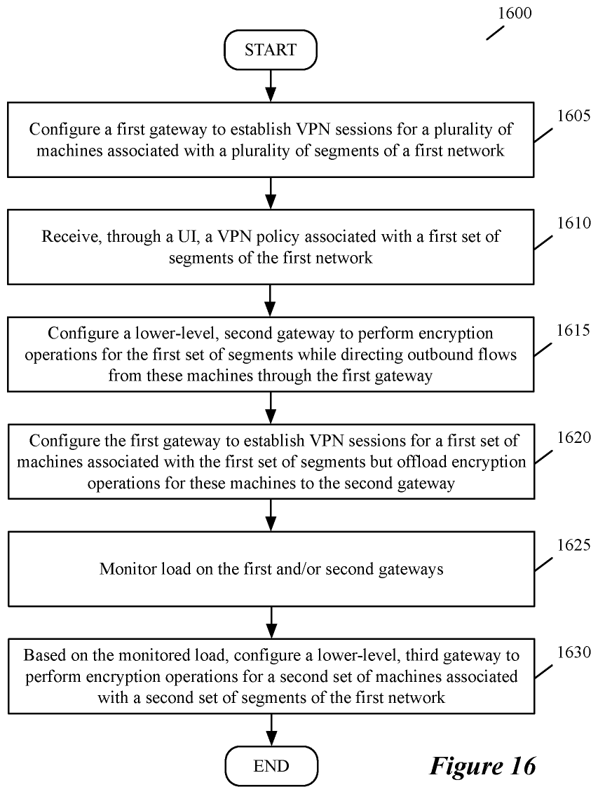

FIG. 16 conceptually illustrates a process 1600 of some embodiments for dynamically performing data message encryption operations for several machines of a first network at several gateways. This process 1600 may be performed by a cluster of one or more servers (e.g., an SDDC controller or manager cluster) of the first network that deploy and configure gateways in the first network. The first and second networks may be SDDCs. The data message encryption is in some embodiments needed for VPN communication with a second network.

The process begins by configuring (at 1605) a first gateway to establish VPN sessions for several machines associated with several segments of the first network. The first gateway in some embodiments is the default gateway of the first network. The machines in some embodiments include VMs. The server cluster of some embodiments uses the first gateway to establish VPN sessions by providing VPN policies to the first gateway for the first gateway to establish the VPN sessions. The first gateway can use this information to negotiate one or more SAs and one or more keys for the VPN sessions.

Next, the process 1600 receives (at 1610), through a user interface (UI), a VPN policy that is associated with a first set of segments of the first network. In some embodiments, the VPN policy is received in an API. In other embodiments, the VPN policy is received through a GUI. In such embodiments, the GUI may include a UI control through which a user specifies the first set of segments. For instance, the UI control may be a drop down window, a field to provide a set of network addresses (e.g., Internet Protocol (IP) values), a field to specify an IP prefix or a Classless Inter-Domain Routing (CIDR), etc. The VPN policy may be received by the set of controllers from a set of one or more managers of the first network, that manage the set of controllers, that received the policy through the UI.

In some embodiments, the first set of segments associated with the VPN policy includes several segments such that the VPN policy is defined by reference to the several segments. In other embodiments, the first set of segments associated with the VPN policy includes only one particular segment such that the VPN policy is defined by reference to the particular segment. For instance, a user may define a VPN policy for only one segment of the first network, or may define one VPN policy for several segments of the first network. These segments may be shown to the user through the UI (e.g., in a GUI) for the user to select for the VPN policy.

At 1615, the process 1600 configures a lower-level, second gateway to perform encryption operations for the first set of segments while directing outbound flows from these machines through the first gateway. While the server cluster configures the first gateway to establish VPN sessions and forward data message flows along the VPN sessions, the server cluster configures the second gateway to perform at least a subset of the encryption operations for the VPN sessions. By offloading the encryption operations, the load on the first gateway is reduced.

At 1620, the process 1600 configures the first gateway to establish VPN sessions for a first set of machines associated with the first set of segments but offload encryption operations for these machines to the second gateway. In some embodiments, the server cluster provides the received VPN policy to the first gateway to establish one or more VPN sessions for the first set of segments. The first gateway uses the VPN policy to negotiate one or more SAs and one or more keys for the VPN sessions.

The server cluster of some embodiments configures the first gateway to offload encryption operations by configuring the first gateway with one or more next-hop forwarding records. The next-hop forwarding record specifies that ingress data message flows (i.e., flows entering the first network) are to be offloaded to their respective gateway. For instance, the next-hop forwarding record specifies that data message flows destined to machines in the first set of machines are to be directed to the second gateway. For egress data message flows (i.e., flows exiting the first network), the server cluster of some embodiments configures the second gateway gateway with one or more next-hop forwarding records specifying that the data message flows are to be forwarded to the first gateway that establishes VPN sessions. For instance, the server cluster can configure the second gateway (e.g., at step 1615) with a next-hop forwarding record specifying that data messages received from the first set of machines are to be forwarded to the first gateway after the second gateway performs encryption operations on the flows.

In some embodiments, the server cluster configures the first gateway to provide the SAs and keys, negotiated by the first gateway during VPN session establishment, to the second gateway to use to perform encryption operations. The server cluster in some embodiments also configures the first gateway to provide records identifying the data message flows associated with the first set of machines to the second gateway.

Then, at 1625, the process 1600 monitors load on the first and/or second gateways to determine when to deploy one or more additional gateways in the first network. In some embodiments, the first gateway performs the encryption operations for other machines associated with one or more other segments based on a different VPN policy. In such embodiments, the other VPN policy associated with the other segments was received by the server cluster through the UI, and the server cluster configures the first gateway to establish other VPN sessions for the other machines based on this VPN policy. The server cluster in some embodiments monitors the load on the first gateway to determine when to offload at least some encryption operations of the first gateway to a different gateway, and may alternatively or conjunctively monitor the load on the second gateway to determine when to offload at least some encryption operations of the second gateway to a different gateway.

Based on the monitored load, the process 1600 configures (at 1630) a lower-level, third gateway to perform encryption operations for a second set of machines associated with a second set of segments of the first network. This third gateway may be deployed in the first network in order to alleviate the load on the first and/or second gateways. For example, the server cluster can monitor the load on the second gateway. The server cluster uses the third gateway to perform encryption operations for the second set of machines based on the monitored load by (1) determining that the load on the second gateway by the first set of machines exceeds a particular threshold, and (2) deploying the third gateway in the first network to perform the encryption operations for the second set of machines associated with the second set of segments.

The second set of machines in such embodiments is a first subset of the first set of machines and the second set of segments is a first subset of the first set of segments. The second gateway in some embodiments continues to perform encryption operations for a second subset of the first set of machines associated with a second subset of the first set of segments. More specifically, when the server cluster determines that the load on the second gateway exceeds the particular threshold, the server cluster splits the first set of machines into first and second subsets of machines, so that the third gateway can take on the load of the first subset of machines and the second gateway can keep only the load of the second subset of machines. This helps prevent the second gateway from being overloaded.

In other embodiments, the server cluster monitors the load on the first gateway. In such embodiments, the server cluster configures the third gateway to perform encryption operations for the second set of machines based on the monitored load by (1) determining that the load on the first gateway exceeds a particular threshold, and (2) deploying the third gateway in the first network to perform the encryption operations for the second set of machines associated with the third set of segments.

The second set of machines in such embodiments is a first subset of a third set of machines and the second set of segments is a first subset of a second set of segments for which the first gateway initially performs encryption operations. The first gateway in some embodiments continues to perform encryption operations for a second subset of the third set of machines associated with a second subset of the third set of segments. More specifically, when the server cluster determines that the load on the first gateway exceeds the particular threshold, the server cluster splits the third set of machines into first and second subsets of machines, so that the third gateway can take on the load of the first subset of machines and the first gateway can keep only the load of the second subset of machines. This helps prevent the first gateway from being overloaded. After configuring the third gateway to perform encryption operations for the second set of machines, the process 1600 ends.

As mentioned above, the operations 1625 and 1630 can result in the offloading of the flows from either the default gateway or an encryption gateway. Both these scenarios will now be further described by reference to the example illustrated in FIG. 13. In some embodiments, the default gateway 1310 and the first additional encryption gateway 1330 in FIG. 13 are initially deployed and configured so that the first encryption gateway 1330 encrypts data messages for segment 1360, while the default gateway 1310 encrypts data messages for other machines that are part of other segments of the same network (e.g., the same logical network as the segment 1360, or in the same SDDC 1300 as the segment 1370).

A cluster of one or more servers (e.g., an SDDC controller or manager cluster) monitors the load on the default gateway 1310, and determines that the load on the default gateway 1310 has exceeded a threshold value (i.e., that the default gateway is overloaded) and hence needs some of its encryption operations offloaded. After determining this, the server cluster deploys the second additional encryption gateway 1340 to perform encryption operations for the segment 1370. After deploying the second encryption gateway 1340, the default gateway 1310 does not have to encrypt data messages for the segment 1370 anymore, alleviating the load on the default gateway 1310.

In the above example, operations 1625 and 1630 offload flows from the default gateway to a new encryption gateway. In other situations, these operations 1625 and 1630 offload flows from one encryption gateway to another new encryption gateway. Again, assume that in the example illustrated in FIG. 13, the default gateway 1310 and the first additional encryption gateway 1330 in FIG. 13 are initially deployed and configured so that the first encryption gateway 1330 encrypts data messages for segments 1360 and 1370, while the default gateway 1310 encrypts data messages for other machines that are part of other segments of the same network (e.g., the same logical network as the segment 1360, or in the same SDDC 1300 as the segments 1360 and 1370).

Now, assume that instead of detecting that the default gateway 1310 is overloaded, the monitoring server cluster determines that the load on the first encryption gateway 1330 has exceeded a certain threshold. After this determination, the monitoring server cluster deploys and configures the second additional encryption gateway 1340 to perform encryption operations for the segment 1370. After deploying the second encryption gateway 1340, the first encryption gateway 1330 does not have to encrypt data messages for the segment 1370 anymore, alleviating the load on the first encryption gateway 1330.

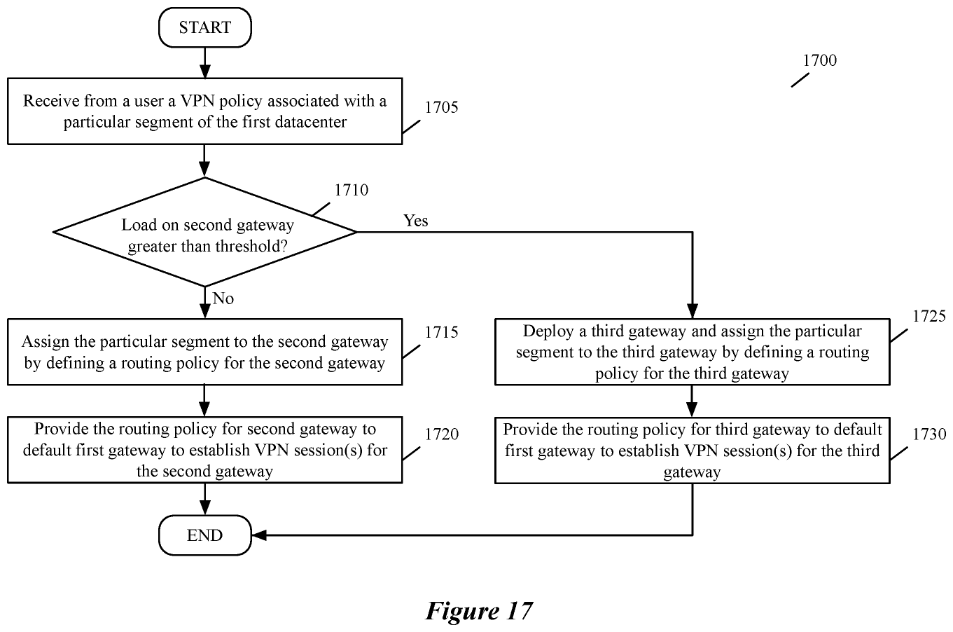

FIG. 17 conceptually illustrates a process 1700 of some embodiments for assigning data message encryption for different segments of a first datacenter to different gateways of the first datacenter. The data message encryption is needed in some embodiments for VPN communication with a second datacenter. This process 1700 is a more detailed process than process 1600, in which the lower level-second gateway is monitored in order to determine when to add additional gateways to the first datacenter. The process 1700 may be performed by a set of one or more controllers of the first datacenter that deploy and configure gateways in the first datacenter. The first datacenter may be an SDDC. In some embodiments, the first datacenter includes a default first gateway that establishes VPN sessions with a set of datacenters including the second datacenter, and a second gateway that performs data message encryption needed for communication with a second datacenter for a set of one or more segments of the first datacenter. The default first gateway in some embodiments performs data message encryption for a different set of segments of the first datacenter.

The process 1700 begins by receiving (at 1705) from a user a particular VPN policy associated with a particular segment of the first datacenter. In some embodiments, the VPN policy is received as an API from the user. In other embodiments, it is received through a GUI. The VPN policy of some embodiments is defined by the user using a set of traffic selectors, which are a set of IP prefixes defining several segments of the first datacenter. The VPN policy of some embodiments is first received by a set of one or more managers of the first datacenter, which provides it to the set of controllers. The particular segment may include a particular set of machines of the first datacenter. The set of machines can include VMs, containers, Pods, etc. In some embodiments, the particular segment is defined by the user. In other embodiments, the particular segment was previously defined by the set of controllers, and the user is provided specification of the particular segment in an API or in the GUI in order to define a VPN policy for the particular segment.

Next, the process 1700 determines (at 1710) whether a load on the second gateway exceeds a particular threshold. The load on the second gateway refers to the amount of data messages the second gateway is currently encrypting for the set of segments already assigned to the second gateway. In some embodiments, the controller set determines whether a future load (e.g., a predicted load) on the second gateway would exceed the particular threshold if the particular segment were to be assigned to it. For example, if the particular threshold is 80% and if assigning the particular segment to the second gateway would result in over 80% utilization of the second gateway, the controller set would determine that the load on the second gateway exceeds the particular threshold. In other embodiments, the controller set determines whether the load currently exceeds the particular threshold. For example, if the controller set determines that even without the particular segment, the second gateway's utilization is over 80%, the controller set would determine that the load on the second gateway exceeds the particular threshold.

If the process 1700 determines that the load on the second gateway does not exceed the particular threshold, the process 1700 assigns (at 1715) the particular segment to the second gateway by defining a routing policy for the second gateway. This routing policy is in some embodiments a record or table specifying that the particular segment is assigned to the second gateway. In some embodiments, the controller set updates an already existing routing policy for the second gateway to specify it is assigned the particular segment. In other embodiments, the controller set defines a new routing policy specifying the second gateway is assigned the particular segment.

After assigning the particular segment to the second gateway, the process 1700 provides (at 1720) the routing policy for the second gateway to the default first gateway for the default first VPN gateway to establish one or more VPN sessions for the particular segment for which the second gateway will perform data message encryption. In some embodiments, in addition to providing the routing policy, the controller set also provides the definition of the particular VPN policy to the default first gateway. Using the information provided by the controller set, the default first gateway negotiates one or more SAs and one or more keys for the one or more VPN sessions, assigns the one or more SAs to the second gateway, and provides the SA and key information to the second gateway. After providing the routing policy, the process 1700 ends.

If the process 1700 determines (at 1710) that the load on the second gateway exceeds the particular threshold, the process 1700 deploys (at 1725) a third gateway in the first datacenter and assigns the particular segment to the third gateway by defining a routing policy for the third gateway. Similar to the routing policy for the second gateway, this routing policy is in some embodiments a record or table specifying that the particular segment is assigned to the third gateway. In some embodiments, the controller set defines a new routing policy specifying the third gateway is assigned the particular segment. Then, the process 1700 provides (at 1730) the routing policy for the third gateway to the default first gateway for the default first gateway to establish one or more VPN sessions for the particular segment for which the third gateway will perform data message encryption. In some embodiments, in addition to providing the routing policy, the controller set also provides the definition of the particular policy to the default first gateway. Using the information provided by the controller set, the default first gateway negotiates one or more SAs and one or more keys for the one or more VPN sessions, assigns the one or more SAs to the third gateway, and provides the SA and key information to the third gateway. After providing the routing policy, the process 1700 ends.

The process 1700 may be performed each time a new VPN policy for a segment is defined by a user, such that the controller set can add additional gateways to the first datacenter each time a segment is defined. In other embodiments, additional gateways are deployed in a datacenter based on monitoring the load on currently deployed gateways. For instance, the controller set may include a monitoring process (e.g., as a monitoring program, application, or module) that monitors the load on the second gateway performing encryption for the set of segments. When the load on the second gateway exceeds a particular threshold, the controller set can deploy the third gateway, reassign a subset of the set of segments to the third gateway, define new routing policies for both the second and third gateways, and provide the new routing policies to the default first gateway.

These new routing policies in some would specify that the third gateway is assigned the subset of the set of segments, and the second gateway is assigned segments in the set of segments not in the subset assigned to the third gateway. For example, if the controller set divides the set of segments into a first subset of segments for the second gateway and a second subset of segments for the third gateway, the controller set would define routing policies specifying the second gateway is assigned the first subset of segments and the third gateway is assigned the second subset of segments.

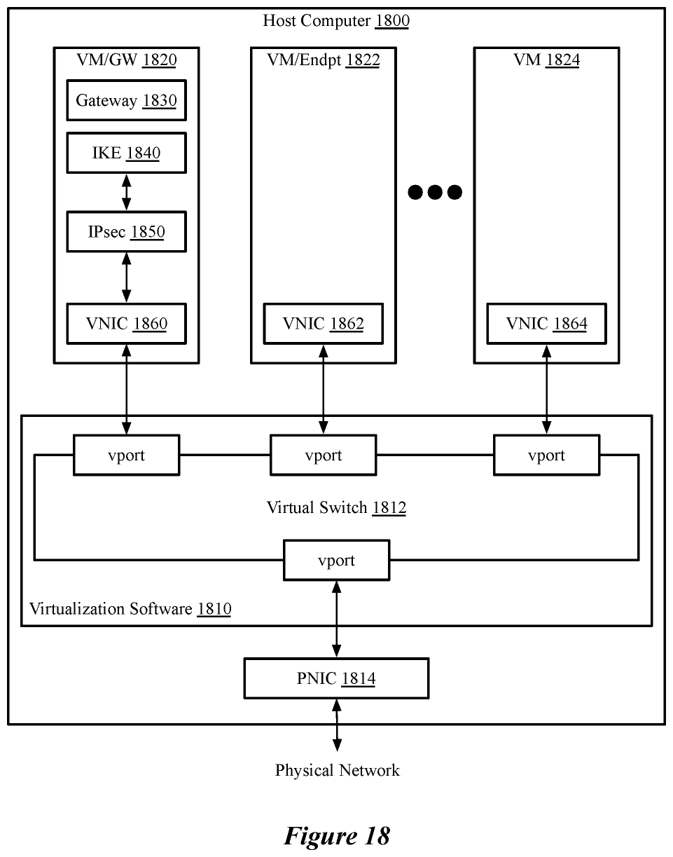

In some embodiments, the operations to perform data message encryption are implemented by a virtual machine, container, or other data compute node that operates as the sending gateway in a virtualized environment. FIG. 18 illustrates a block diagram of a host computer 1800 of some embodiments in a virtualized networking environment. As illustrated, the host computer 1800 includes virtualization software 1810, a PNIC 1814 (physical network interface card), and multiple VMs 1820, 1822, and 1824.

In some embodiments, the host computer 1800 is a physical general-purpose computer (e.g., a server, workstation, etc.) and includes one or more physical central processing units (CPUs), a system memory, and non-volatile data storage. The host computer 1800 also includes one or more physical network interfaces, such as PNIC 1814, for communicating with other hardware computing platforms, entities, or host computers on a physical network accessible through PNIC 1814. In some embodiments, the host computer 1800 may provide part of the computing infrastructure in a virtualized computing environment distributed among multiple host computers. Though certain embodiments are described herein with respect to VMs, the same principals and techniques may also apply to other appropriate virtualized data compute nodes (e.g., virtual machine, container, pod, data compute node, isolated user space instance) as well as physical computing devices.

The virtualization software 1810 (e.g., a hypervisor) serves as an interface between VMs 1820-1824 and the PNIC 1814, as well as other physical resources (e.g., CPUs, memory, etc.) available on host computer 1800, in some embodiments. Each of the VMs 1820-1824 is shown including a VNIC 1860-1864 respectively, which is responsible for exchanging packets between each respective VM and the virtualization software 1810. The architecture of the virtualization software 1810 may vary across different embodiments of the invention. In some embodiments, the virtualization software 1810 can be installed as system-level software directly on the host computer 1800 (i.e., a “bare metal” installation) and be conceptually interposed between the physical hardware and the guest operating systems executing in the VMs. In other embodiments, the virtualization software 1810 may conceptually run “on top of” a conventional host operating system in the server.

In some embodiments, the virtualization software 1810 includes both system-level software and a privileged VM (not shown) configured to have access to the physical hardware resources (e.g., CPUs, physical interfaces, etc.) of the host computer 1810. While the VNICs 1860-1864 are shown as included in the VMs 1820-1824, it should be understood that VNICs 1860-1864 may be implemented by code (e.g., VM monitor code) associated with virtualization software 1810 in some embodiments, while in other embodiments, the VNICs 1860-1864 may be software implementations of PNICs. Each of the VMs 1820-1824 is connected to a virtual port (also referred to herein as a vport or virtual interface) provided by a virtual switch 1812 through the VNICs 1860-1864 associated with the VMs. In some embodiments, the virtual switch 1812 serves as physical network switch (i.e., serves as an edge device on the physical network, but is implemented in software). The virtual switch 1812 is connected to the PNIC 1814 in order to allow network traffic to be exchanged between the VMs 1820-1824 executing on host computer 1800 and destinations on an external physical network.

In some embodiments, a VM executing on the host computer 1800 is configured to perform the functions of a gateway. For instance, the VM 1820 in this example is configured as a gateway, such as the encryption gateway 814 described above, and includes a gateway layer or component 1830 that logically represents a set of instructions for implementing gateway functions. The gateway VM 1820 is also configured with an IKE control stack 1840 (also referred to as an IKE daemon) similar to the IKE control stack 1122 described above.

The gateway VM 1820 of some embodiments is also configured to implement IPsec protocols and functionality using an IPsec tunnels datapath 1850. Like the IPsec tunnels datapath 1124 described above, the IPsec tunnels datapath 1850 of some embodiments encrypts outgoing packets to be provided to a default gateway, such as the gateway 814 described above, by encapsulating the outgoing packets with, e.g., ESP headers based on a corresponding outbound SA. In each packet's ESP header, IPsec tunnels datapath 1850 also includes an SPI value, associated with the outbound SA. IPsec tunnels datapath 1850 is also configured to decrypt incoming encapsulated ESP encrypted packets received from a default gateway, such as gateway 812 described above.

In some embodiments, another VM executing on host computer 1800, or on another host computer, may be configured as an endpoint associated with the gateway VM 1820. For instance, the VM 1822 in this example is an endpoint VM 1822 associated with gateway VM 1820. In some embodiments, a source endpoint at a first site may generate a packet to send to a destination endpoint at a second site. For instance, in a VPN session, a source endpoint operating in a datacenter may want to send a packet to a destination endpoint operating in another datacenter. To do so, the source endpoint in the datacenter may forward the packet to the gateway VM 1820 which performs the encryption and provides the packet to a default gateway of the datacenter.

When a packet is received at the host computer 1800, in some embodiments, the packet is provided to the virtual switch 1812 of host computer 1800 via the PNIC 1814. In some embodiments, the virtual switch 1812 sends the encapsulated encrypted packet to VNIC 1860 of gateway VM 1820 to decrypt and provide to a destination VM. It should be noted that while that FIG. 18 illustrates only one example of a gateway, other embodiments may include other virtual computing instances for performing the functions of a gateway. In still other embodiments, the gateway may be a physical computing device.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

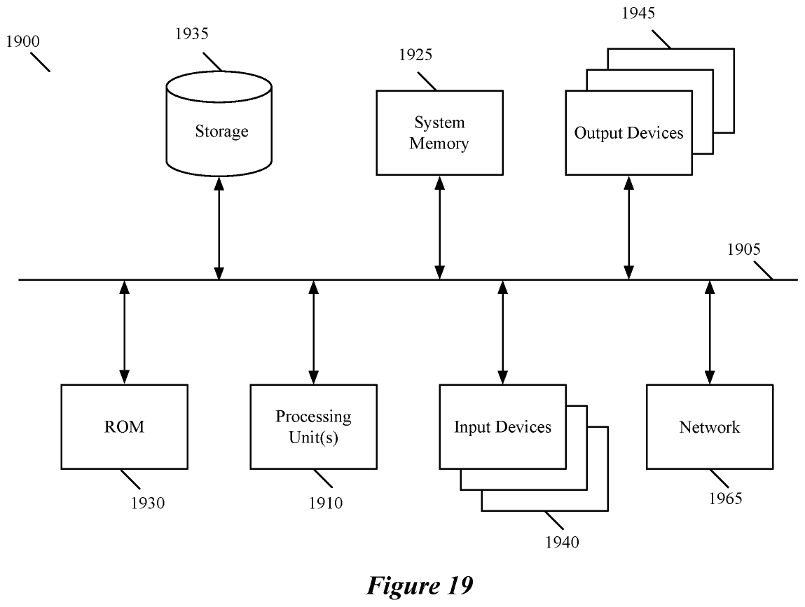

FIG. 19 conceptually illustrates a computer system 1900 with which some embodiments of the invention are implemented. The computer system 1900 can be used to implement any of the above-described computers and servers. As such, it can be used to execute any of the above described processes. This computer system includes various types of non-transitory machine readable media and interfaces for various other types of machine readable media. Computer system 1900 includes a bus 1905, processing unit(s) 1910, a system memory 1925, a read-only memory 1930, a permanent storage device 1935, input devices 1940, and output devices 1945.

The bus 1905 collectively represents all system, peripheral, and chipset buses that communicatively connect the numerous internal devices of the computer system 1900. For instance, the bus 1905 communicatively connects the processing unit(s) 1910 with the read-only memory 1930, the system memory 1925, and the permanent storage device 1935.

From these various memory units, the processing unit(s) 1910 retrieve instructions to execute and data to process in order to execute the processes of the invention. The processing unit(s) may be a single processor or a multi-core processor in different embodiments. The read-only-memory (ROM) 1930 stores static data and instructions that are needed by the processing unit(s) 1910 and other modules of the computer system. The permanent storage device 1935, on the other hand, is a read-and-write memory device. This device is a non-volatile memory unit that stores instructions and data even when the computer system 1900 is off. Some embodiments of the invention use a mass-storage device (such as a magnetic or optical disk and its corresponding disk drive) as the permanent storage device 1935.

Other embodiments use a removable storage device (such as a flash drive, etc.) as the permanent storage device. Like the permanent storage device 1935, the system memory 1925 is a read-and-write memory device. However, unlike storage device 1935, the system memory is a volatile read-and-write memory, such a random access memory. The system memory stores some of the instructions and data that the processor needs at runtime. In some embodiments, the invention's processes are stored in the system memory 1925, the permanent storage device 1935, and/or the read-only memory 1930. From these various memory units, the processing unit(s) 1910 retrieve instructions to execute and data to process in order to execute the processes of some embodiments.

The bus 1905 also connects to the input and output devices 1940 and 1945. The input devices enable the user to communicate information and select commands to the computer system. The input devices 1940 include alphanumeric keyboards and pointing devices (also called “cursor control devices”). The output devices 1945 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 19, bus 1905 also couples computer system 1900 to a network 1965 through a network adapter (not shown). In this manner, the computer can be a part of a network of computers (such as a local area network (“LAN”), a wide area network (“WAN”), or an Intranet, or a network of networks, such as the Internet. Any or all components of computer system 1900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. In addition, a number of the figures (including FIGS. 3, 4, 6, 7, 16, and 17) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for dynamically performing data message encryption operations for a plurality of machines of a first network at a plurality of gateways, the data message encryption needed for virtual private network (VPN) communication with a second network, the method comprising:
receiving, through a user interface (UI), a VPN policy that is associated with a first set of segments of the first network;
using a higher-level, first gateway to establish VPN sessions for a first set of machines associated with the first set of segments, while using a lower-level, second gateway to perform encryption operations for the first set of machines and using the first gateway to perform encryption operations for a second set of machines associated with a second set of segments of the first network;
monitoring load on the first or second gateways; and
based on the monitored load, using a lower-level, third gateway to perform encryption operations for a third set of machines associated with a third set of segments of the first network.

2. The method of claim 1, wherein receiving the VPN policy through the UI comprises receiving the VPN policy in an Application Programming Interface (API).

3. The method of claim 1, wherein receiving the VPN policy through the UI comprises receiving the VPN policy through a graphical user interface (GUI).

4. The method of claim 3, wherein the GUI comprises a UI control through which a user specifies the first set of segments.

5. The method of claim 1, wherein using the first gateway to establish the VPN sessions comprises providing the VPN policy to the first gateway for the first gateway to establish the VPN sessions.

6. The method of claim 1, wherein the first set of segments comprises a plurality of segments such that the VPN policy is defined by reference to the plurality of segments.

7. The method of claim 1, wherein the first set of segments comprises only one particular segment such that the VPN policy is defined by reference to the particular segment.

8. The method of claim 1, wherein monitoring load on the first or second gateways comprises monitoring load on the second gateway.

9. The method of claim 8, wherein using the third gateway to perform encryption operations for the third set of machines based on the monitored load comprises:
determining that the load on the second gateway by the first set of machines exceeds a particular threshold; and
deploying the third gateway in the first network to perform the encryption operations for the third set of machines associated with the third set of segments, wherein the third set of machines is a first subset of the first set of machines and the third set of segments is a first subset of the first set of segments.

10. The method of claim 9, wherein the second gateway continues to perform encryption operations for a second subset of the first set of machines associated with a second subset of the first set of segments.

11. The method of claim 1, wherein monitoring load on the first or second gateways comprises monitoring load on the first gateway.

12. The method of claim 11, wherein using the third gateway to perform encryption operations for the third set of machines based on the monitored load comprises:
determining that the load on the first gateway by the second set of machines exceeds a particular threshold; and
deploying the third gateway in the first network to perform the encryption operations for the third set of machines associated with the third set of segments, wherein the third set of machines is a first subset of the second set of machines and the third set of segments is a first subset of the second set of segments.

13. The method of claim 12, wherein the first gateway continues to perform encryption operations for a second subset of the second set of machines associated with a second subset of the second set of segments.

14. The method of claim 1, wherein the VPN policy is a first VPN policy, and the first gateway performs the encryption operations for the second set of machines associated with the second set of segments based on a second VPN policy that is associated with the second set of segments.

15. The method of claim 1, wherein each set of machines comprises virtual machines (VMs) executing on a set of one or more host computers in the first network.

16. The method of claim 15, wherein a first machine in the first set of machines and a second machine in the second set of machines operate on a same host computer.

17. The method of claim 1, wherein the receiving, using, and monitoring operations are performed by a set of one or more controllers of the first network.

18. The method of claim 1, wherein receiving the VPN policy comprises receiving the VPN policy from a set of one or more managers of the first network that received the policy through the UI.

19. A non-transitory machine readable medium storing a program for execution by at least one processing unit for dynamically performing data message encryption operations for a plurality of machines of a first network at a plurality of gateways, the data message encryption needed for virtual private network (VPN) communication with a second network, the program comprising sets of instructions for:
receiving, through a user interface (UI), a VPN policy that is associated with a first set of segments of the first network;
using a higher-level, first gateway to establish VPN sessions for a first set of machines associated with the first set of segments, while using a lower-level, second gateway to perform encryption operations for the first set of machines and using the first gateway to perform encryption operations for a second set of machines associated with a second set of segments of the first network;
monitoring load on the first or second gateways; and
based on the monitored load, using a lower-level, third gateway to perform encryption operations for a third set of machines associated with a third set of segments of the first network.

20. The non-transitory machine readable medium of claim 19, wherein the set of instructions for monitoring load on the first or second gateways further comprises a set of instructions for monitoring load on the second gateway, and the set of instructions for using the third gateway to perform encryption operations for the third set of machines based on the monitored load further comprises sets of instructions for:
determining that the load on the second gateway by the first set of machines exceeds a particular threshold; and
deploying the third gateway in the first network to perform the encryption operations for the third set of machines associated with the third set of segments, wherein the third set of machines is a first subset of the first set of machines and the third set of segments is a first subset of the first set of segments.
